(19) United States
(12) Patent Application Publication
(10) Pub. No.: US 2025/0097836 A1
(43) Pub. Date: Mar. 20, 2025

(54) INFORMATION TRANSMITTING METHOD AND APPARATUS, INFORMATION RECEIVING METHOD AND APPARATUS, DEVICE, AND STORAGE MEDIUM

(71) Applicant: Beijing Xiaoml Mobile Software Co., Lid., Beijing (CN)

(72) Inventor: Ting FU, Beijing (CN)

(21) Appl. No.: 18/728,566

(22) PCT Filed: Jan. 13, 2022
(86) PCT No.: PCT/CN2022/071863

§ 371 Date: Jul. 12, 2024

(51) Int. Cl. H04W 52/02; H04W 72/0446

(52) U.S. Cl. CPC H04W 52/02; H04W 72/0446

(57) ABSTRACT

An information transmission method is executed by a network device, and includes: determining resource information corresponding to a sending occasion of a wake-up signal, wherein the resource information includes one or more of time domain resource information, frequency domain resource information, and code domain resource information; and sending the wake-up signal to a user equipment based on the resource information corresponding to the sending occasion, wherein the sending occasion is periodic.

### CROSS REFERENCE

The present application is a U.S. national phase application of International Application No. PCT/CN2022/071863, filed on Jan. 13, 2022, the entire content of which is incorporated herein by reference.

### TECHNICAL FIELD

The present disclosure relates to the field of wireless communication technology, and in particular to an information transmission and reception method, apparatus, device and storage medium.

### BACKGROUND

A low-power wake-up signal (WUS) is introduced in R18. The user equipment uses a separate receiver to receive the WUS. The user equipment needs to use the main transceiver for normal processing of the downlink and uplink data. If the WUS received by the user equipment indicates wake-up, the user equipment will turn on the main receiver to receive and process the downlink signal. If the WUS is not received or the received WUS indicates not to wake up, the user equipment will keep the main receiver in a sleep state.

### SUMMARY

In view of this, the present disclosure provides an information transmission and reception method, apparatus, device and storage medium.

According to a first aspect of the embodiment of the present disclosure, there is provided an information transmission method, which is executed by a network device and includes:
determining resource information corresponding to a sending occasion of a wake-up signal, wherein the resource information includes one or more of time domain resource information, frequency domain resource information, and code domain resource information; and
sending the wake-up signal to a user equipment based on the resource information corresponding to the sending occasion,
wherein the sending occasion is periodic.

According to a second aspect of the embodiment of the present disclosure, there is provided an information receiving method, executed by a user equipment, including:
determining resource information corresponding to a monitoring occasion of a wake-up signal, wherein the resource information includes one or more of time domain resource information, frequency domain resource information, and code domain resource information; and
receiving the wake-up signal sent by a network device based on the resource information corresponding to the sending occasion,
wherein the monitoring occasion is periodic.

According to a third aspect of the embodiment of the present disclosure, there is provided an information transmission apparatus, applied to a network device, including:
a processing module, configured to determine resource information corresponding to a sending occasion of a wake-up signal, wherein the resource information includes one or more of time domain resource information, frequency domain resource information, and code domain resource information; and
a sending module, configured to send the wake-up signal to a user equipment based on the resource information corresponding to the sending occasion;
wherein the sending occasion is periodic.

According to a fourth aspect of the embodiment of the present disclosure, there is provided an information receiving apparatus, applied to a user equipment, including:
a processing module, configured to determine resource information corresponding to a monitoring occasion of a wake-up signal, wherein the resource information includes one or more of time domain resource information, frequency domain resource information, and code domain resource information; and
a receiving module, configured to receive the wake-up signal sent by a network device based on the resource information corresponding to the sending occasion,
wherein the monitoring occasion is periodic.

According to a fifth aspect of the embodiment of the present disclosure, there is provided a network device, including:
a processor; and
a memory for storing processor-executable instructions;
wherein the processor is configured to execute executable instructions in the memory to implement steps of the above information transmission method.

According to a sixth aspect of the embodiment of the present disclosure, there is provided a mobile terminal, including:
a processor; and
a memory for storing processor-executable instructions;
wherein the processor is configured to execute executable instructions in the memory to implement steps of the above information receiving method.

According to a seventh aspect of the embodiment of the present disclosure, there is provided a non-transitory computer-readable storage medium having executable instructions stored thereon, which, when executed by a processor, implement steps of the above information transmission method or the above information receiving method.

It is to be understood that both the foregoing general description and the following detailed description are exemplary and explanatory only and are not restrictive of the present disclosure.

### BRIEF DESCRIPTION OF THE DRAWINGS

The accompanying drawings herein are incorporated in and constitute a part of the specification, illustrate embodiments consistent with the embodiments of the present disclosure, and together with the description, serve to explain the principles of the embodiments of the present disclosure.

FIG. 1 is a flow chart showing a method of information transmission method according to an exemplary embodiment;

FIG. 2 is a flow chart showing a method of information transmission method according to an exemplary embodiment;

FIG. 3 is a flow chart showing a method of information transmission method according to an exemplary embodiment;

FIG. 4 is a flow chart showing a method of information transmission method according to an exemplary embodiment;

FIG. 5 is a flow chart showing a method of information transmission method according to an exemplary embodiment;

FIG. 6 is a flow chart showing a method of information transmission method according to an exemplary embodiment;

FIG. 7 is a flow chart showing a method of information transmission method according to an exemplary embodiment;

FIG. 8 is a flow chart showing a method of information transmission method according to an exemplary embodiment;

FIG. 9 is a flow chart showing a method of information transmission method according to an exemplary embodiment;

FIG. 10 is a flow chart of a method of information receiving method according to an exemplary embodiment;

FIG. 11 is a flow chart of a method of information receiving method according to an exemplary embodiment;

FIG. 12 is a flow chart of a method of information receiving method according to an exemplary embodiment;

FIG. 13 is a flow chart of a method of information receiving method according to an exemplary embodiment;

FIG. 14 is a flow chart of a method of information receiving method according to an exemplary embodiment;

FIG. 15 is a flow chart of a method of information receiving method according to an exemplary embodiment;

FIG. 16 is a flow chart of a method of information receiving method according to an exemplary embodiment;

FIG. 17 is a flow chart of a method of information receiving method according to an exemplary embodiment;

FIG. 18 is a flow chart of a method of information receiving method according to an exemplary embodiment;

FIG. 19 is a block diagram of an information transmission apparatus according to an exemplary embodiment;

FIG. 20 is a block diagram of an information receiving apparatus according to an exemplary embodiment;

FIG. 21 is a structural diagram of an information transmission device according to an exemplary embodiment;

FIG. 22 is a structural diagram of an information receiving device according to an exemplary embodiment.

### DETAILED DESCRIPTION

Exemplary embodiments will be described in detail herein, examples of which are shown in the accompanying drawings. When the following description refers to the drawings, unless otherwise indicated, the same numbers in different drawings represent the same or similar elements. The implementations described in the following exemplary embodiments do not represent all implementations consistent with the embodiments of the present disclosure. Instead, they are merely examples of devices and methods consistent with some aspects of the present disclosure as detailed in the appended claims.

It should be noted that an embodiment of the present disclosure may include multiple steps; for the convenience of description, these steps are numbered; however, these numbers are not limitations on the execution time slots and execution order between the steps; these steps can be implemented in any order, and the embodiment of the present disclosure does not limit this.

In the scenario where the network device sends a wake-up signal, the user equipment needs to obtain the time domain, frequency domain, and code domain resource information for sending the wake-up signal in advance so that it can correctly receive the wake-up signal.

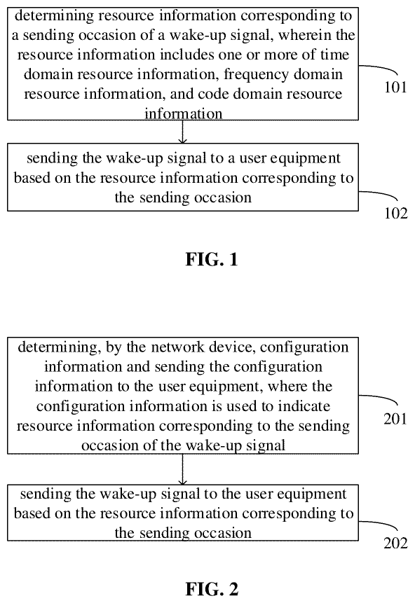

The embodiment of the present disclosure provides an information transmission method, which is executed by a network device. The method can be executed independently or in combination with any other embodiment of the embodiment of the present disclosure. FIG. 1 is a flowchart of an information transmission method according to an exemplary embodiment. As shown in FIG. 1, the method includes:
Step 101, determining resource information corresponding to a sending occasion of a wake-up signal, wherein the resource information includes one or more of time domain resource information, frequency domain resource information, and code domain resource information; and
Step 102: sending the wake-up signal to a user equipment based on the resource information corresponding to the sending occasion;
wherein the sending occasion is periodic.

In one embodiment, the network device determines resource information corresponding to the sending occasion of the wake-up signal, the resource information includes one or more of time domain resource information, frequency domain resource information and code domain resource information, and the network device sends the wake-up signal to the user equipment based on the resource information corresponding to the sending occasion. The sending occasion is periodic, that is, the network device periodically sends the wake-up signal to the user equipment.

In the above implementation, the network device determines the resource information corresponding to the sending occasion of the wake-up signal, so that the user equipment can obtain the time domain, frequency domain, and code domain resource information for sending the wake-up signal, thereby being able to correctly receive the wake-up signal.

The embodiment of the present disclosure provides an information transmission method, which is executed by a network device. The method can be executed independently or in combination with any other embodiment of the embodiment of the present disclosure. FIG. 2 is a flowchart of an information transmission method according to an exemplary embodiment. As shown in FIG. 2, the method includes:
Step 201, determining, by the network device, configuration information and sending the configuration information to the user equipment, where the configuration information is used to indicate resource information corresponding to the sending occasion of the wake-up signal; and
Step 202: sending the wake-up signal to the user equipment based on the resource information corresponding to the sending occasion;
wherein the sending occasion is periodic, and the resource information includes one or more of time domain resource information, frequency domain resource information and code domain resource information.

In one embodiment, the network device determines configuration information and sends the configuration information to the user equipment, where the configuration information is used to indicate resource information corresponding to the sending occasion of the wake-up signal, where the resource information includes one or more of time domain resource information, frequency domain resource information, and code domain resource information. The network device sends the wake-up signal to the user equipment based on the resource information corresponding to the sending occasion. The sending occasion is periodic, that is, the network device periodically sends the wake-up signal to the user equipment.

In one embodiment, the network device determines configuration information and sends the configuration information to the user equipment, where the configuration information is used to indicate resource information corresponding to the sending occasion of the wake-up signal, where the resource information includes one or more of time domain resource information, frequency domain resource information, and code domain resource information. The network device sends the wake-up signal to the user equipment based on the resource information corresponding to the sending occasion. The sending occasion is periodic, that is, the network device periodically sends the wake-up signal to the user equipment. The frequency domain resource information includes frequency domain position information, and the frequency domain position information indicates that the frequency domain position of sending the wake-up signal is the same as the frequency domain position of the control resource set (Control Resource Set) CORESET 0.

In one embodiment, the network device determines configuration information and sends the configuration information to the user equipment, where the configuration information is used to indicate resource information corresponding to the sending occasion of the wake-up signal, where the resource information includes one or more of time domain resource information, frequency domain resource information, and code domain resource information. The network device sends the wake-up signal to the user equipment based on the resource information corresponding to the sending occasion. The sending occasion is periodic, that is, the network device periodically sends the wake-up signal to the user equipment. The frequency domain resource information includes frequency domain position information, where the frequency domain position information indicates that the center position of the frequency domain position of sending the wake-up signal is the same as the center position of the frequency domain position of CORESET 0.

In one embodiment, the network device determines configuration information and sends the configuration information to the user equipment, where the configuration information is used to indicate resource information corresponding to the sending occasion of the wake-up signal, and the resource information includes one or more of time domain resource information, frequency domain resource information, and code domain resource information. The network device sends a wake-up signal to the user equipment based on the resource information corresponding to the sending occasion. The sending occasion is periodic, that is, the network device periodically sends the wake-up signal to the user equipment. In the embodiment, the frequency domain resource information includes frequency domain position information, and the frequency domain position information includes at least one of; the number of resource blocks occupied by the frequency domain position, and the index of the starting resource block in the resource blocks occupied by the frequency domain position.

In one embodiment, the code domain resource information includes characteristics of an orthogonal code sequence corresponding to the wake-up signal.

In the above implementation, the user equipment is in radio resource control (Resource Control (RRC) idle state.

In the above implementation, the network device determines the resource information corresponding to the sending occasion of the wake-up signal, so that the user equipment can obtain the time domain, frequency domain, and code domain resource information for sending the wake-up signal, thereby being able to correctly receive the wake-up signal.

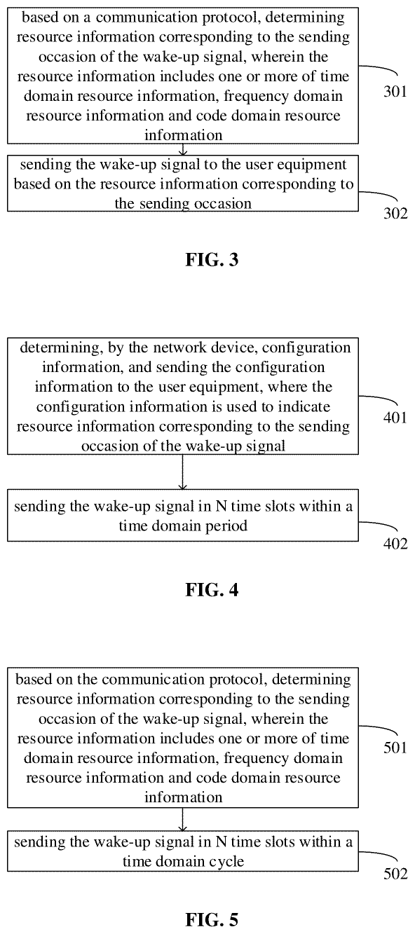

The embodiment of the present disclosure provides an information transmission method, which is executed by a network device. The method can be executed independently or in combination with any other embodiment of the embodiment of the present disclosure. FIG. 3 is a flowchart of an information transmission method according to an exemplary embodiment. As shown in FIG. 3, the method includes:
Step 301, based on a communication protocol, determining resource information corresponding to the sending occasion of the wake-up signal, wherein the resource information includes one or more of time domain resource information, frequency domain resource information and code domain resource information; and
Step 302: sending the wake-up signal to the user equipment based on the resource information corresponding to the sending occasion;
wherein the sending occasion is periodic.

In one embodiment, the network device determines according to the communication protocol the resource information corresponding to the sending occasion of the wake-up signal, and the resource information includes one or more of time domain resource information, frequency domain resource information, and code domain resource information. The network device sends the wake-up signal to the user equipment based on the resource information corresponding to the sending occasion. The sending occasion is periodic, that is, the network device periodically sends the wake-up signal to the user equipment.

In one embodiment, the network device determines according to the communication protocol the resource information corresponding to the sending occasion of the wake-up signal, and the resource information includes one or more of time domain resource information, frequency domain resource information, and code domain resource information. The network device sends the wake-up signal to the user equipment based on the resource information corresponding to the sending occasion. The sending occasion is periodic, that is, the network device periodically sends the wake-up signal to the user equipment. In the embodiment, the frequency domain resource information includes frequency domain position information, and the frequency domain position information indicates that the frequency domain position of sending the wake-up signal is the same as the frequency domain position of CORESET 0.

In one embodiment, the network device determines according to the communication protocol the resource information corresponding to the sending occasion of the wake-up signal, and the resource information includes one or more of time domain resource information, frequency domain resource information, and code domain resource information. The network device sends the wake-up signal to the user equipment based on the resource information corresponding to the sending occasion. The sending occasion is periodic, that is, the network device periodically sends the wake-up signal to the user equipment. In the embodiment, the frequency domain resource information includes frequency domain position information, and the frequency domain position information indicates that the center position of the frequency domain position of sending the wake-up signal is the same as the center position of the frequency domain position of CORESET 0.

In one embodiment, the network device determines according to the communication protocol the resource information corresponding to the sending occasion of the wake-up signal, and the resource information includes one or more of time domain resource information, frequency domain resource information, and code domain resource information. The network device sends the wake-up signal to the user equipment based on the resource information corresponding to the sending occasion. The sending occasion is periodic, that is, the network device periodically sends the wake-up signal to the user equipment. In the embodiment, the frequency domain resource information includes frequency domain position information, and the frequency domain position information includes at least one of: the number of resource blocks occupied by the frequency domain position, and the index of the starting resource block in the resource block occupied by the frequency domain position.

In one embodiment, the code domain resource information includes characteristics of an orthogonal code sequence corresponding to the wake-up signal.

In the above implementation, the user equipment is in the RRC idle state.

In the above implementation, the network device determines the resource information corresponding to the sending occasion of the wake-up signal, so that the user equipment can obtain the time domain, frequency domain, and code domain resource information for sending the wake-up signal, thereby being able to correctly receive the wake-up signal.

The embodiment of the present disclosure provides an information transmission method, which is executed by a network device. The method can be executed independently or in combination with any other embodiment of the embodiment of the present disclosure. The method includes:
determining, by the network device, configuration information and sending the configuration information to the user equipment, where the configuration information is used to indicate resource information corresponding to the sending occasion of the wake-up signal; and
sending the wake-up signal to the user equipment based on the resource information corresponding to the sending occasion;
wherein the sending occasion is periodic, and the resource information includes one or more of time domain resource information, frequency domain resource information and code domain resource information.

In one embodiment, the network device determines configuration information and sends the configuration information to the user equipment, where the configuration information is used to indicate resource information corresponding to the sending occasion of the wake-up signal, and the resource information includes one or more of time domain resource information, frequency domain resource information, and code domain resource information. The network device sends a wake-up signal to the user equipment based on the resource information corresponding to the sending occasion. The sending occasion is periodic, that is, the network device periodically sends the wake-up signal to the user equipment. In the embodiment, the frequency domain resource information includes frequency domain position information, and the frequency domain position information includes at least one of: the bandwidth part (BWP) where the wake-up signal is located, the number of resource blocks occupied by the frequency domain position, and the index of the starting resource block in the resource blocks occupied by the frequency domain position.

In one embodiment, the network device determines configuration information and sends the configuration information to the user equipment, where the configuration information is used to indicate resource information corresponding to the sending occasion of the wake-up signal, and the resource information includes one or more of time domain resource information, frequency domain resource information, and code domain resource information. The network device sends a wake-up signal to the user equipment based on the resource information corresponding to the sending occasion. The sending occasion is periodic, that is, the network device periodically sends the wake-up signal to the user equipment. In response to the frequency domain resource information being determined based on the communication protocol, the frequency domain resource information includes frequency domain position information, and the frequency domain position information indicates that the frequency domain position of the wake-up signal is the same as the bandwidth position of the activated BWP of the user equipment.

In one embodiment, the network device determines configuration information and sends the configuration information to the user equipment, where the configuration information is used to indicate resource information corresponding to the sending occasion of the wake-up signal, and the resource information includes one or more of time domain resource information, frequency domain resource information, and code domain resource information. The network device sends a wake-up signal to the user equipment based on the resource information corresponding to the sending occasion. The sending occasion is periodic, that is, the network device periodically sends the wake-up signal to the user equipment. In response to the frequency domain resource information being determined based on the communication protocol, the frequency domain resource information includes frequency domain location information, and the frequency domain location information indicates that the wake-up signal is on a default BWP, where the default BWP is specified by the communication protocol.

In one embodiment, the code domain resource information includes characteristics of an orthogonal code sequence corresponding to the wake-up signal.

In the above implementation, the user equipment is in a radio resource control RRC connected state.

In the above implementation, the network device determines the resource information corresponding to the sending occasion of the wake-up signal, so that the user equipment can obtain the time domain, frequency domain, and code domain resource information for sending the wake-up signal, thereby being able to correctly receive the wake-up signal.

The embodiment of the present disclosure provides an information transmission method, which is executed by a network device. The method can be executed independently or in combination with any other embodiment of the embodiment of the present disclosure. The method includes:
determining, based on the communication protocol, resource information corresponding to the sending occasion of the wake-up signal, where the resource information includes one or more of time domain resource information, frequency domain resource information, and code domain resource information; and
sending the wake-up signal to the user equipment based on the resource information corresponding to the sending occasion;
wherein the sending occasion is periodic.

In one embodiment, the network device determines according to the communication protocol the resource information corresponding to the sending occasion of the wake-up signal, and the resource information includes one or more of time domain resource information, frequency domain resource information, and code domain resource information. The network device sends the wake-up signal to the user equipment based on the resource information corresponding to the sending occasion. The sending occasion is periodic, that is, the network device periodically sends the wake-up signal to the user equipment. In the embodiment, the frequency domain resource information includes frequency domain position information, and the frequency domain position information includes at least one of: the bandwidth part BWP where the wake-up signal is located, the number of resource blocks occupied by the frequency domain position, and the index of the starting resource block in the resource block occupied by the frequency domain position.

In one embodiment, the network device determines according to the communication protocol the resource information corresponding to the sending occasion of the wake-up signal, and the resource information includes one or more of time domain resource information, frequency domain resource information, and code domain resource information. The network device sends the wake-up signal to the user equipment based on the resource information corresponding to the sending occasion. The sending occasion is periodic, that is, the network device periodically sends the wake-up signal to the user equipment. In response to the frequency domain resource information being determined based on the communication protocol, the frequency domain resource information includes frequency domain position information, and the frequency domain position information indicates that the frequency domain position of the wake-up signal is the same as the bandwidth position of the activated BWP of the user equipment.

In one embodiment, the network device determines according to the communication protocol the resource information corresponding to the sending occasion of the wake-up signal, and the resource information includes one or more of time domain resource information, frequency domain resource information, and code domain resource information. The network device sends the wake-up signal to the user equipment based on the resource information corresponding to the sending occasion. The sending occasion is periodic, that is, the network device periodically sends the wake-up signal to the user equipment. In which, in response to the frequency domain resource information being determined based on the communication protocol, the frequency domain resource information includes frequency domain position information, and the frequency domain position information indicates that the wake-up signal is on a default BWP, wherein the default BWP is specified by the communication protocol.

In the above implementation, the user equipment is in a radio resource control RRC connected state.

In the above implementation, the network device determines the resource information corresponding to the sending occasion of the wake-up signal, so that the user equipment can obtain the time domain, frequency domain, and code domain resource information for sending the wake-up signal, thereby being able to correctly receive the wake-up signal.

The embodiment of the present disclosure provides an information transmission method, which is executed by a network device. The method can be executed independently or in combination with any other embodiment of the embodiment of the present disclosure. The method includes:
determining, by the network device, configuration information, and sending the configuration information to the user equipment, where the configuration information is used to indicate resource information corresponding to the sending occasion of the wake-up signal; and
sending the wake-up signal to the user equipment based on the resource information corresponding to the sending occasion;
wherein the sending occasion is periodic, and the resource information includes one or more of time domain resource information, frequency domain resource information and code domain resource information.

In one embodiment, the network device determines configuration information and sends the configuration information to the user equipment, where the configuration information is used to indicate resource information corresponding to the sending occasion of the wake-up signal, where the resource information includes one or more of time domain resource information, frequency domain resource information, and code domain resource information. The network device sends the wake-up signal to the user equipment based on the resource information corresponding to the sending occasion. The sending occasion is periodic, that is, the network device periodically sends the wake-up signal to the user equipment. The time domain resource information includes time domain period information, and the time domain period information includes the time domain period size and the period start position offset,

In the above implementation, the user equipment is in the RRC idle state or the RRC connected state.

In the above implementation, the network device determines the resource information corresponding to the sending occasion of the wake-up signal, so that the user equipment can obtain the time domain, frequency domain, and code domain resource information for sending the wake-up signal, thereby being able to correctly receive the wake-up signal.

The embodiment of the present disclosure provides an information transmission method, which is executed by a network device. The method can be executed independently or in combination with any other embodiment of the embodiment of the present disclosure. The method includes:
determining, based on the communication protocol, resource information corresponding to the sending occasion of the wake-up signal, where the resource information includes one or more of time domain resource information, frequency domain resource information, and code domain resource information; and
sending the wake-up signal to the user equipment based on the resource information corresponding to the sending occasion;
wherein the sending occasion is periodic.

In one embodiment, the network device determines the resource information corresponding to the sending occasion of the wake-up signal based on the communication protocol, and the resource information includes one or more of time domain resource information, frequency domain resource information, and code domain resource information. The network device sends the wake-up signal to the user equipment based on the resource information corresponding to the sending occasion. The sending occasion is periodic, that is, the network device periodically sends the wake-up signal to the user equipment. In the embodiment, the time domain resource information includes time domain cycle information, and the time domain cycle information includes the time domain cycle size and the cycle start position offset.

In the above implementation, the user equipment is in an RRC idle state or an RRC connected state.

In the above implementation, the network device determines the resource information corresponding to the sending occasion of the wake-up signal, so that the user equipment can obtain the time domain, frequency domain, and code domain resource information for sending the wake-up signal, thereby being able to correctly receive the wake-up signal.

The embodiment of the present disclosure provides an information transmission method, which is executed by a network device. The method can be executed independently or in combination with any other embodiment of the embodiment of the present disclosure. FIG. 4 is a flowchart of an information transmission method according to an exemplary embodiment. As shown in FIG. 4, the method includes:
Step 401, determining, by the network device, configuration information, and sending the configuration information to the user equipment, where the configuration information is used to indicate resource information corresponding to the sending occasion of the wake-up signal; and
Step 402, sending the wake-up signal in N time slots within a time domain period, where N is a positive integer greater than 1;
wherein the sending occasion is periodic, the resource information includes one or more of time domain resource information, frequency domain resource information and code domain resource information, and the time domain resource information includes time domain period information.

In one embodiment, the network device determines configuration information and sends the configuration information to the user equipment, where the configuration information is used to indicate resource information corresponding to the sending occasion of the wake-up signal, where the resource information includes one or more of time domain resource information, frequency domain resource information, and code domain resource information, wherein the time domain resource information includes time domain period information. The network device sends the wake-up signal to the user equipment based on the resource information corresponding to the sending occasion, and the sending occasion is periodic. That is, within a time domain period, the network device sends a wake-up signal on N time slots of the time domain period. For example, the network device sends a wake-up signal on the first 4 time slots of a time domain period.

In one embodiment, the network device determines configuration information and sends the configuration information to the user equipment, where the configuration information is used to indicate resource information corresponding to the sending occasion of the wake-up signal, where the resource information includes one or more of time domain resource information, frequency domain resource information, and code domain resource information, wherein the time domain resource information includes time domain period information. The network device sends the wake-up signal to the user equipment based on the resource information corresponding to the sending occasion, and the sending occasion is periodic. That is, within a time domain period, the network device sends N sequences of wake-up signals in N time slots of the time domain period, respectively. In the embodiment, the wake-up signal is carried in sequences, and the N sequences are different. In this way, the user equipment can determine in which time slot each sequence is received by receiving the sequence of the wake-up signal.

In one embodiment, the value of N is configured by the network device. In one embodiment, the value of N is defined by the communication protocol.

In the above implementation, the user equipment is in the RRC idle state or the RRC connected state.

In the above implementation, the network device determines the resource information corresponding to the sending occasion of the wake-up signal, so that the user equipment can obtain the time domain, frequency domain, and code domain resource information for sending the wake-up signal, thereby being able to correctly receive the wake-up signal.

The embodiment of the present disclosure provides an information transmission method, which is executed by a network device. The method can be executed independently or in combination with any other embodiment of the embodiment of the present disclosure. FIG. 5 is a flowchart of an information transmission method according to an exemplary embodiment. As shown in FIG. 5, the method includes:
Step 501, based on the communication protocol, determining resource information corresponding to the sending occasion of the wake-up signal, wherein the resource information includes one or more of time domain resource information, frequency domain resource information and code domain resource information, and the time domain resource information includes time domain period information; and
Step 502, sending the wake-up signal in N time slots within a time domain cycle, where N is a positive integer greater than 1;
wherein the sending occasion is periodic.

In one embodiment, based on the communication protocol, resource information corresponding to the sending occasion of the wake-up signal is determined, and the resource information includes one or more of time domain resource information, frequency domain resource information, and code domain resource information, wherein the time domain resource information includes time domain period information. The network device sends the wake-up signal to the user equipment based on the resource information corresponding to the sending occasion, and the sending occasion is periodic. That is, within a time domain period, the network device sends the wake-up signal in N time slots of the time domain period. For example, the network device sends the wake-up signal in the first 4 time slots of a time domain period.

In one embodiment, based on the communication protocol, the resource information corresponding to the sending occasion of the wake-up signal is determined, and the resource information includes one or more of time domain resource information, frequency domain resource information, and code domain resource information, wherein the time domain resource information includes time domain period information. The network device sends the wake-up signal to the user equipment based on the resource information corresponding to the sending occasion, and the sending occasion is periodic. That is, within a time domain period, the network device sends N sequences of wake-up signals in N time slots of the time domain period respectively. In the embodiment, the wake-up signal is carried in sequences, and the N sequences are different. In this way, the user equipment can determine in which time slot each sequence is received by receiving the sequence of the wake-up signal.

In one embodiment, the value of N is configured by the network device. In one embodiment, the value of N is defined by the communication protocol.

In the above implementation, the user equipment is in the RRC idle state or the RRC connected state.

In the above implementation, the network device determines the resource information corresponding to the sending occasion of the wake-up signal, so that the user equipment can obtain the time domain, frequency domain, and code domain resource information for sending the wake-up signal, thereby being able to correctly receive the wake-up signal.

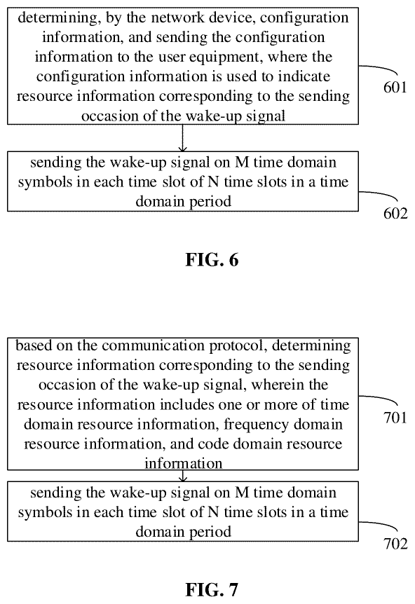

The embodiment of the present disclosure provides an information transmission method, which is executed by a network device. The method can be executed independently or in combination with any other embodiment of the embodiment of the present disclosure. FIG. 6 is a flowchart of an information transmission method according to an exemplary embodiment. As shown in FIG. 6, the method includes:
Step 601, determining, by the network device, configuration information, and sending the configuration information to the user equipment, where the configuration information is used to indicate resource information corresponding to the sending occasion of the wake-up signal; and
Step 602, sending the wake-up signal on M time domain symbols in each time slot of N time slots in a time domain period, where N and M are both positive integers greater than 1;
wherein the sending occasion is periodic, the resource information includes one or more of time domain resource information, frequency domain resource information and code domain resource information, and the time domain resource information includes time domain period information.

In one embodiment, the network device determines configuration information and sends the configuration information to the user equipment, where the configuration information is used to indicate resource information corresponding to the sending occasion of the wake-up signal, where the resource information includes one or more of time domain resource information, frequency domain resource information, and code domain resource information, wherein the time domain resource information includes time domain period information. The network device sends a wake-up signal to the user equipment based on the resource information corresponding to the sending occasion, and the sending occasion is periodic. That is, within a time domain period, the network device sends the wake-up signal on M time domain symbols in each of the N time slots of the time domain period. For example, the network device sends a wake-up signal on the first 4 time slots of a time domain period, and when sending the wake-up signal on the first 4 time slots, the wake-up signal is sent on the first 3 time domain symbols in each of the 4 time slots.

In one embodiment, the network device determines configuration information and sends the configuration information to the user equipment, where the configuration information is used to indicate resource information corresponding to the sending occasion of the wake-up signal, and the resource information includes one or more of time domain resource information, frequency domain resource information, and code domain resource information, wherein the time domain resource information includes time domain period information. The network device sends a wake-up signal to the user equipment based on the resource information corresponding to the sending occasion, and the sending occasion is periodic. That is, within a time domain period, the network device sends the wake-up signal on M time domain symbols in each of the N time slots of the time domain period, and sends M sequences of the wake-up signal on the M time domain symbols respectively. In the embodiment, the wake-up signal is carried in sequences, and the M sequences are different. In this way, the user equipment can determine on which time domain symbol each sequence is received by receiving the sequence of the wake-up signal.

In one embodiment, the values of N and M are configured by the network device. In one embodiment, the values of N and M are defined by the communication protocol.

In the above implementation, the user equipment is in the RRC idle state or the RRC connected state.

In the above implementation, the network device determines the resource information corresponding to the sending occasion of the wake-up signal, so that the user equipment can obtain the time domain, frequency domain, and code domain resource information for sending the wake-up signal, thereby being able to correctly receive the wake-up signal.

The embodiment of the present disclosure provides an information transmission method, which is executed by a network device. The method can be executed independently or in combination with any other embodiment of the embodiment of the present disclosure. FIG. 7 is a flowchart of an information transmission method according to an exemplary embodiment. As shown in FIG. 7, the method includes:
Step 701, based on the communication protocol, determining resource information corresponding to the sending occasion of the wake-up signal, wherein the resource information includes one or more of time domain resource information, frequency domain resource information, and code domain resource information, and the time domain resource information includes time domain period information; and
Step 702, sending the wake-up signal on M time domain symbols in each time slot of N time slots in a time domain period, where N and M are both positive integers greater than 1;
wherein the sending occasion is periodic.

In one embodiment, based on the communication protocol, the resource information corresponding to the sending occasion of the wake-up signal is determined, and the resource information includes one or more of time domain resource information, frequency domain resource information, and code domain resource information, wherein the time domain resource information includes time domain period information. The network device sends the wake-up signal to the user equipment based on the resource information corresponding to the sending occasion, and the sending occasion is periodic. That is, within a time domain period, the network device sends the wake-up signal on M time domain symbols in each of the N time slots of the time domain period. For example, the network device sends the wake-up signal on the first 4 time slots of a time domain period, and when sending the wake-up signal on the first 4 time slots, the wake-up signal is sent on the first 3 time domain symbols in each of the 4 time slots.

In one embodiment, based on the communication protocol, the resource information corresponding to the sending occasion of the wake-up signal is determined, and the resource information includes one or more of time domain resource information, frequency domain resource information, and code domain resource information, wherein the time domain resource information includes time domain period information. The network device sends the wake-up signal to the user equipment based on the resource information corresponding to the sending occasion, and the sending occasion is periodic. That is, within a time domain period, the network device sends the wake-up signal on M time domain symbols in each of the N time slots of the time domain period, and sends M sequences of the wake-up signal on the M time domain symbols respectively. In the embodiment, the wake-up signal is carried in sequences, and the M sequences are different. In this way, the user equipment can determine on which time domain symbol each sequence is received by receiving the sequence of the wake-up signal.

In one embodiment, the values of N and M are configured by the network device. In one embodiment, the values of N and M are defined by the communication protocol.

In the above implementation, the user equipment is in the RRC idle state or the RRC connected state.

In the above implementation, the network device determines the resource information corresponding to the sending occasion of the wake-up signal, so that the user equipment can obtain the time domain, frequency domain, and code domain resource information for sending the wake-up signal, thereby being able to correctly receive the wake-up signal.

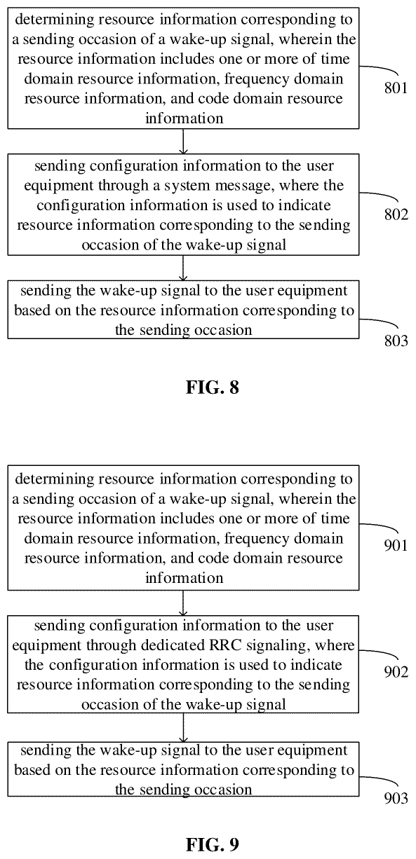

The embodiment of the present disclosure provides an information transmission method, which is executed by a network device. The method can be executed independently or in combination with any other embodiment of the embodiment of the present disclosure. FIG. 8 is a flowchart of an information transmission method according to an exemplary embodiment. As shown in FIG. 8, the method includes:
Step 801, determining resource information corresponding to a sending occasion of a wake-up signal, wherein the resource information includes one or more of time domain resource information, frequency domain resource information, and code domain resource information;
Step 802: sending configuration information to the user equipment through a system message, where the configuration information is used to indicate resource information corresponding to the sending occasion of the wake-up signal; and
Step 803: sending the wake-up signal to the user equipment based on the resource information corresponding to the sending occasion;
wherein the sending occasion is periodic; and the user equipment is in an RRC idle state.

In one embodiment, the network device determines resource information corresponding to the sending occasion of the wake-up signal, and the resource information includes one or more of time domain resource information, frequency domain resource information, and code domain resource information. The network device broadcasts configuration information through a system message, and the configuration information is used to indicate the resource information corresponding to the sending occasion of the wake-up signal. The network device sends the wake-up signal to the user equipment based on the resource information corresponding to the sending occasion. The sending occasion is periodic, that is, the network device periodically sends the wake-up signal to the user equipment. In the embodiment, the user equipment is in an RRC idle state.

In the above implementation, the network device determines the resource information corresponding to the sending occasion of the wake-up signal, so that the user equipment can obtain the time domain, frequency domain, and code domain resource information for sending the wake-up signal, thereby being able to correctly receive the wake-up signal.

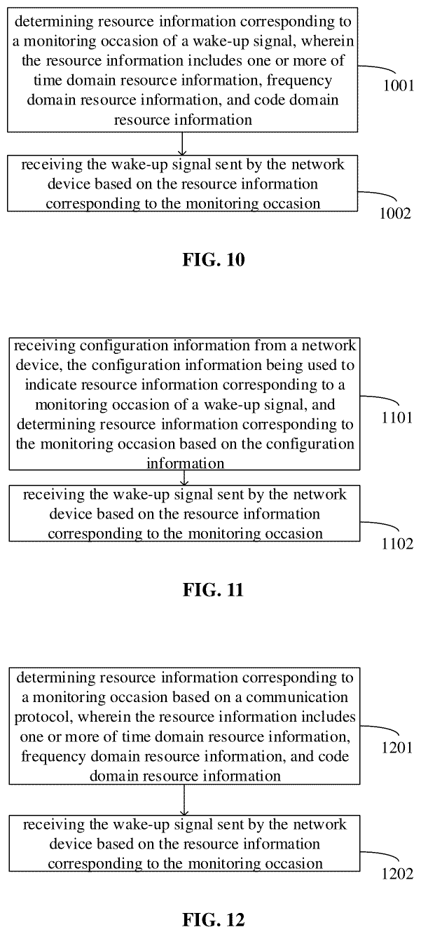

The embodiment of the present disclosure provides an information transmission method, which is executed by a network device. The method can be executed independently or in combination with any other embodiment of the embodiment of the present disclosure. FIG. 9 is a flowchart of an information transmission method according to an exemplary embodiment. As shown in FIG. 9, the method includes:
Step 901, determining resource information corresponding to a sending occasion of a wake-up signal, wherein the resource information includes one or more of time domain resource information, frequency domain resource information, and code domain resource information;
Step 902: sending configuration information to the user equipment through dedicated RRC signaling, where the configuration information is used to indicate resource information corresponding to the sending occasion of the wake-up signal; and
Step 903: sending the wake-up signal to the user equipment based on the resource information corresponding to the sending occasion;
wherein the sending occasion is periodic; and the user equipment is in an RRC connected state.

In one embodiment, the network device determines resource information corresponding to the sending occasion of the wake-up signal, and the resource information includes one or more of time domain resource information, frequency domain resource information, and code domain resource information. The network device sends configuration information through dedicated RRC signaling, and the configuration information is used to indicate the resource information corresponding to the sending occasion of the wake-up signal. The network device sends the wake-up signal to the user equipment based on the resource information corresponding to the sending occasion. The sending occasion is periodic, that is, the network device periodically sends the wake-up signal to the user equipment. In the embodiment, the user equipment is in an RRC connected state.

In the above implementation, the network device determines the resource information corresponding to the sending occasion of the wake-up signal, so that the user equipment can obtain the time domain, frequency domain, and code domain resource information for sending the wake-up signal, thereby being able to correctly receive the wake-up signal.

The embodiment of the present disclosure provides a method for receiving information, which is executed by a user equipment. The method can be executed independently or in combination with any other embodiment of the embodiment of the present disclosure. FIG. 10 is a flowchart of an information transmission method according to an exemplary embodiment. As shown in FIG. 10, the method includes:
Step 1001, determining resource information corresponding to a monitoring occasion of a wake-up signal, wherein the resource information includes one or more of time domain resource information, frequency domain resource information, and code domain resource information; and
Step 1002: receiving the wake-up signal sent by the network device based on the resource information corresponding to the monitoring occasion;
wherein the monitoring occasion is periodic.

In one embodiment, the user equipment determines resource information corresponding to the monitoring occasion of the wake-up signal, the resource information includes one or more of time domain resource information, frequency domain resource information and code domain resource information, and the user equipment receives the wake-up signal sent by the network device based on the resource information corresponding to the monitoring occasion. The monitoring occasion is periodic, that is, the user equipment periodically receives the wake-up signal sent by the network device.

In the above implementation, the user equipment determines the resource information corresponding to the monitoring occasion of the wake-up signal, so that the user equipment can obtain the time domain, frequency domain, and code domain resource information for receiving the wake-up signal, thereby being able to correctly receive the wake-up signal.

The embodiment of the present disclosure provides a method for receiving information, which is executed by a user equipment. The method can be executed independently or in combination with any other embodiment of the embodiment of the present disclosure. FIG. 11 is a flowchart of an information transmission method according to an exemplary embodiment. As shown in FIG. 11, the method includes:
Step 1101, receiving configuration information from a network device, the configuration information being used to indicate resource information corresponding to a monitoring occasion of a wake-up signal, and determining resource information corresponding to the monitoring occasion based on the configuration information; and
Step 1102, receiving the wake-up signal sent by the network device based on the resource information corresponding to the monitoring occasion;
wherein the monitoring occasion is periodic, and the resource information includes one or more of time domain resource information, frequency domain resource information and code domain resource information.

In one embodiment, a user equipment receives configuration information from a network device, the configuration information is used to indicate resource information corresponding to a monitoring occasion of a wake-up signal, and determines resource information corresponding to the monitoring occasion based on the configuration information. The user equipment receives the wake-up signal sent by the network device based on the resource information corresponding to the monitoring occasion. The monitoring occasion is periodic, that is, the user equipment periodically receives the wake-up signal sent by the network device. The resource information includes one or more of time domain resource information, frequency domain resource information, and code domain resource information.

In one embodiment, the code domain resource information includes characteristics of an orthogonal code sequence corresponding to the wake-up signal.

In the above implementation, the user equipment determines the resource information corresponding to the monitoring occasion of the wake-up signal, so that the user equipment can obtain the time domain, frequency domain, and code domain resource information for receiving the wake-up signal, thereby being able to correctly receive the wake-up signal.

The embodiment of the present disclosure provides a method for receiving information, which is executed by a user equipment. The method can be executed independently or in combination with any other embodiment of the embodiment of the present disclosure. FIG. 12 is a flowchart of an information transmission method according to an exemplary embodiment. As shown in FIG. 12, the method includes:
Step 1201, determining resource information corresponding to a monitoring occasion based on a communication protocol, wherein the resource information includes one or more of time domain resource information, frequency domain resource information, and code domain resource information; and
Step 1202: receiving the wake-up signal sent by the network device based on the resource information corresponding to the monitoring occasion;
wherein the monitoring occasion is periodic.

The user equipment determines resource information corresponding to the monitoring occasion based on the communication protocol, and the resource information includes one or more of time domain resource information, frequency domain resource information, and code domain resource information. The user equipment receives the wake-up signal sent by the network device based on the resource information corresponding to the monitoring occasion. The monitoring occasion is periodic, that is, the user equipment periodically receives the wake-up signal sent by the network device.

In one embodiment, the code domain resource information includes characteristics of an orthogonal code sequence corresponding to the wake-up signal.

In the above implementation, the user equipment determines the resource information corresponding to the monitoring occasion of the wake-up signal, so that the user equipment can obtain the time domain, frequency domain, and code domain resource information for receiving the wake-up signal, thereby being able to correctly receive the wake-up signal.

The embodiment of the present disclosure provides a method for receiving information, which is executed by a user equipment. The method can be executed independently or in combination with any other embodiment of the embodiment of the present disclosure. The method includes:
determining resource information corresponding to the monitoring occasion of the wake-up signal, where the resource information includes one or more of time domain resource information, frequency domain resource information, and code domain resource information;
based on the resource information corresponding to the monitoring occasion, receiving the wake-up signal sent by the network device, wherein the monitoring occasion is periodic;
wherein the determining the resource information corresponding to the monitoring occasion of the wake-up signal includes:
in response to the frequency domain resource information not being determined based on the configuration information received from the network device, determining that the frequency domain position of the wake-up signal is the same as the bandwidth position of the activated bandwidth part BWP of the user equipment; wherein the configuration information is used to indicate the resource information corresponding to the monitoring occasion of the wake-up signal.

In one embodiment, the user equipment determines resource information corresponding to the monitoring occasion of the wake-up signal, and the resource information includes one or more of time domain resource information, frequency domain resource information, and code domain resource information. The user equipment receives the wake-up signal sent by the network device based on the resource information corresponding to the monitoring occasion. The monitoring occasion is periodic, that is, the user equipment periodically receives the wake-up signal sent by the network device. In a scenario where the frequency domain resource information is not determined based on the configuration information received from the network device, the user equipment determines that the frequency domain position of the wake-up signal is the same as the bandwidth position of the activated bandwidth part BWP of the user equipment.

In the above implementation, the user equipment determines the resource information corresponding to the monitoring occasion of the wake-up signal, so that the user equipment can obtain the time domain, frequency domain, and code domain resource information for receiving the wake-up signal, thereby being able to correctly receive the wake-up signal.

The embodiment of the present disclosure provides a method for receiving information, which is executed by a user equipment. The method can be executed independently or in combination with any other embodiment of the embodiment of the present disclosure. The method includes:
determining resource information corresponding to the monitoring occasion of the wake-up signal, where the resource information includes one or more of time domain resource information, frequency domain resource information, and code domain resource information; and
based on the resource information corresponding to the monitoring occasion, receiving the wake-up signal sent by the network device, wherein the monitoring occasion is periodic;
wherein the resource information corresponding to the monitoring occasion of the wake-up signal is determined includes:
in response to the frequency domain resource information not being determined based on configuration information received from the network device, determining that the wake-up signal is on a default BWP, wherein the default BWP is specified by a communication protocol; and the configuration information is used to indicate resource information corresponding to a monitoring occasion of the wake-up signal.

In one embodiment, the user equipment determines resource information corresponding to the monitoring occasion of the wake-up signal, and the resource information includes one or more of time domain resource information, frequency domain resource information, and code domain resource information. The user equipment receives the wake-up signal sent by the network device based on the resource information corresponding to the monitoring occasion. The monitoring occasion is periodic, that is, the user equipment periodically receives the wake-up signal sent by the network device. In a scenario where the frequency domain resource information is not determined based on the configuration information received from the network device, the user equipment determines that the wake-up signal is on the default BWP, wherein the default BWP is specified by the communication protocol.

In the above implementation, the user equipment determines the resource information corresponding to the monitoring occasion of the wake-up signal, so that the user equipment can obtain the time domain, frequency domain, and code domain resource information for receiving the wake-up signal, thereby being able to correctly receive the wake-up signal.

The embodiment of the present disclosure provides a method for receiving information, which is executed by a user equipment. The method can be executed independently or in combination with any other embodiment of the embodiment of the present disclosure. The method includes:
receiving configuration information from a network device, the configuration information being used to indicate resource information corresponding to a monitoring occasion of a wake-up signal, and determining resource information corresponding to the monitoring occasion based on the configuration information; and
receiving the wake-up signal sent by the network device based on the resource information corresponding to the monitoring occasion;
wherein the monitoring occasion is periodic, and the resource information includes one or more of time domain resource information, frequency domain resource information and code domain resource information.

In one embodiment, a user equipment receives configuration information from a network device, the configuration information is used to indicate resource information corresponding to a monitoring occasion of a wake-up signal, and determines the resource information corresponding to the monitoring occasion based on the configuration information. The user equipment receives the wake-up signal sent by the network device based on the resource information corresponding to the monitoring occasion. The monitoring occasion is periodic, that is, the user equipment periodically receives the wake-up signal sent by the network device. The resource information includes one or more of time domain resource information, frequency domain resource information, and code domain resource information. In the embodiment, the frequency domain resource information includes frequency domain position information, and the frequency domain position information indicates that the frequency domain position of sending the wake-up signal is the same as the frequency domain position of the control resource set CORESET 0.

In one embodiment, a user equipment receives configuration information from a network device, the configuration information is used to indicate resource information corresponding to a monitoring occasion of a wake-up signal, and determines the resource information corresponding to the monitoring occasion based on the configuration information. The user equipment receives the wake-up signal sent by the network device based on the resource information corresponding to the monitoring occasion. The monitoring occasion is periodic, that is, the user equipment periodically receives the wake-up signal sent by the network device. The resource information includes one or more of time domain resource information, frequency domain resource information, and code domain resource information. In the embodiment, the frequency domain resource information includes frequency domain position information, and the frequency domain position information indicates that the center position of the frequency domain position for sending the wake-up signal is the same as the center position of the frequency domain position of the control resource set CORESET 0.

In one embodiment, a user equipment receives configuration information from a network device, the configuration information is used to indicate resource information corresponding to a monitoring occasion of a wake-up signal, and determines the resource information corresponding to the monitoring occasion based on the configuration information, and the user equipment receives the wake-up signal sent by the network device based on the resource information corresponding to the monitoring occasion. The monitoring occasion is periodic, that is, the user equipment periodically receives the wake-up signal sent by the network device. The resource information includes one or more of time domain resource information, frequency domain resource information, and code domain resource information. In the embodiment, the frequency domain resource information includes frequency domain position information, and the frequency domain position information includes at least one of: the number of resource blocks occupied by the frequency domain position, and the index of the starting resource block in the resource block occupied by the frequency domain position.

In the above implementation, the user equipment is in the RRC idle state.

In the above implementation, the user equipment determines the resource information corresponding to the monitoring occasion of the wake-up signal, so that the user equipment can obtain the time domain, frequency domain, and code domain resource information for receiving the wake-up signal, thereby being able to correctly receive the wake-up signal.

The embodiment of the present disclosure provides a method for receiving information, which is executed by a user equipment. The method can be executed independently or in combination with any other embodiment of the embodiment of the present disclosure. The method includes:
determining resource information corresponding to the monitoring occasion based on the communication protocol, where the resource information includes one or more of time domain resource information, frequency domain resource information, and code domain resource information; and
based on the resource information corresponding to the monitoring occasion, receiving the wake-up signal sent by the network device;
wherein the monitoring occasion is periodic.

The user equipment determines the resource information corresponding to the monitoring occasion based on the communication protocol, and the resource information includes one or more of time domain resource information, frequency domain resource information and code domain resource information. The user equipment receives the wake-up signal sent by the network device based on the resource information corresponding to the monitoring occasion. The monitoring occasion is periodic, that is, the user equipment periodically receives the wake-up signal sent by the network device. In the embodiment, the frequency domain resource information includes frequency domain position information, and the frequency domain position information indicates that the frequency domain position of sending the wake-up signal is the same as the frequency domain position of the control resource set CORESET 0.

The user equipment determines the resource information corresponding to the monitoring occasion based on the communication protocol, and the resource information includes one or more of time domain resource information, frequency domain resource information and code domain resource information. The user equipment receives the wake-up signal sent by the network device based on the resource information corresponding to the monitoring occasion. The monitoring occasion is periodic, that is, the user equipment periodically receives the wake-up signal sent by the network device. In the embodiment, the frequency domain resource information includes frequency domain position information, and the frequency domain position information indicates that the center position of the frequency domain position of sending the wake-up signal is the same as the center position of the frequency domain position of the control resource set CORESET 0.

The user equipment determines the resource information corresponding to the monitoring occasion based on the communication protocol, and the resource information includes one or more of time domain resource information, frequency domain resource information and code domain resource information. The user equipment receives the wake-up signal sent by the network device based on the resource information corresponding to the monitoring occasion. The monitoring occasion is periodic, that is, the user equipment periodically receives the wake-up signal sent by the network device. In the embodiment, the frequency domain resource information includes frequency domain position information, and the frequency domain position information includes at least one of: the number of resource blocks occupied by the frequency domain position, and the index of the starting resource block in the resource block occupied by the frequency domain position.

In the above implementation, the user equipment is in a radio resource control RRC idle state.

In the above implementation, the user equipment determines the resource information corresponding to the monitoring occasion of the wake-up signal, so that the user equipment can obtain the time domain, frequency domain, and code domain resource information for receiving the wake-up signal, thereby being able to correctly receive the wake-up signal.

The embodiment of the present disclosure provides a method for receiving information, which is executed by a user equipment. The method can be executed independently or in combination with any other embodiment of the embodiment of the present disclosure. The method includes:
receiving configuration information from a network device, the configuration information being used to indicate resource information corresponding to a monitoring occasion of a wake-up signal, and determining resource information corresponding to the monitoring occasion based on the configuration information; and
receiving the wake-up signal sent by the network device based on the resource information corresponding to the monitoring occasion;
wherein the monitoring occasion is periodic, and the resource information includes one or more of time domain resource information, frequency domain resource information and code domain resource information.

In one embodiment, a user equipment receives configuration information from a network device, the configuration information is used to indicate resource information corresponding to a monitoring occasion of a wake-up signal, and determines the resource information corresponding to the monitoring occasion based on the configuration information, and the user equipment receives the wake-up signal sent by the network device based on the resource information corresponding to the monitoring occasion. The monitoring occasion is periodic, that is, the user equipment periodically receives the wake-up signal sent by the network device. The resource information includes one or more of time domain resource information, frequency domain resource information, and code domain resource information. In the embodiment, the frequency domain resource information includes frequency domain position information, and the frequency domain position information includes at least one of: the BWP where the wake-up signal is located, the number of resource blocks occupied by the frequency domain position, and the index of the starting resource block in the resource block occupied by the frequency domain position.

In one embodiment, a user equipment receives configuration information from a network device, the configuration information is used to indicate resource information corresponding to a monitoring occasion of a wake-up signal, and determines the resource information corresponding to the monitoring occasion based on the configuration information. The user equipment receives the wake-up signal sent by the network device based on the resource information corresponding to the monitoring occasion. The monitoring occasion is periodic, that is, the user equipment periodically receives the wake-up signal sent by the network device. The resource information includes one or more of time domain resource information, frequency domain resource information, and code domain resource information. In the embodiment, in a scenario where the frequency domain resource information is determined based on a communication protocol, the frequency domain resource information includes frequency domain position information, and the frequency domain position information indicates that the frequency domain position of the wake-up signal is the same as the bandwidth position of the activated BWP of the user equipment.

In one embodiment, a user equipment receives configuration information from a network device, the configuration information is used to indicate resource information corresponding to a monitoring occasion of a wake-up signal, and determines the resource information corresponding to the monitoring occasion based on the configuration information. The user equipment receives the wake-up signal sent by the network device based on the resource information corresponding to the monitoring occasion. The monitoring occasion is periodic, that is, the user equipment periodically receives the wake-up signal sent by the network device. The resource information includes one or more of time domain resource information, frequency domain resource information, and code domain resource information. In the embodiment, in a scenario where the frequency domain resource information is determined based on a communication protocol, the frequency domain resource information includes frequency domain location information, and the frequency domain location information indicates that the wake-up signal is on a default BWP, wherein the default BWP is specified by the communication protocol.

In the above implementation, the user equipment is in the RRC connected state.

In the above implementation, the user equipment determines the resource information corresponding to the monitoring occasion of the wake-up signal, so that the user equipment can obtain the time domain, frequency domain, and code domain resource information for receiving the wake-up signal, thereby being able to correctly receive the wake-up signal.

The embodiment of the present disclosure provides a method for receiving information, which is executed by a user equipment. The method can be executed independently or in combination with any other embodiment of the embodiment of the present disclosure. The method includes:
determining resource information corresponding to the monitoring occasion based on the communication protocol, where the resource information includes one or more of time domain resource information, frequency domain resource information, and code domain resource information; and
based on the resource information corresponding to the monitoring occasion, receiving the wake-up signal sent by the network device;
wherein the monitoring occasion is periodic.

The user equipment determines the resource information corresponding to the monitoring occasion based on the communication protocol, and the resource information includes one or more of time domain resource information, frequency domain resource information and code domain resource information. The user equipment receives the wake-up signal sent by the network device based on the resource information corresponding to the monitoring occasion. The monitoring occasion is periodic, that is, the user equipment periodically receives the wake-up signal sent by the network device. In the embodiment, the frequency domain resource information includes frequency domain position information, and the frequency domain position information includes at least one of: the BWP where the wake-up signal is located, the number of resource blocks occupied by the frequency domain position, and the index of the starting resource block in the resource block occupied by the frequency domain position.

The user equipment determines the resource information corresponding to the monitoring occasion based on the communication protocol, and the resource information includes one or more of time domain resource information, frequency domain resource information and code domain resource information. The user equipment receives the wake-up signal sent by the network device based on the resource information corresponding to the monitoring occasion. The monitoring occasion is periodic, that is, the user equipment periodically receives the wake-up signal sent by the network device. In response to the frequency domain resource information being determined based on the communication protocol, the frequency domain resource information includes frequency domain position information, and the frequency domain position information indicates that the frequency domain position of the wake-up signal is the same as the bandwidth position of the activated BWP of the user equipment.

The user equipment determines the resource information corresponding to the monitoring occasion based on the communication protocol, and the resource information includes one or more of time domain resource information, frequency domain resource information and code domain resource information. The user equipment receives the wake-up signal sent by the network device based on the resource information corresponding to the monitoring occasion. The monitoring occasion is periodic, that is, the user equipment periodically receives the wake-up signal sent by the network device. In response to the frequency domain resource information being determined based on the communication protocol, the frequency domain resource information includes frequency domain position information, and the frequency domain position information indicates that the wake-up signal is on the default BWP, wherein the default BWP is specified by the communication protocol.

In the above implementation, the user equipment is in a radio resource control RRC connected state.

In the above implementation, the user equipment determines the resource information corresponding to the monitoring occasion of the wake-up signal, so that the user equipment can obtain the time domain, frequency domain, and code domain resource information for receiving the wake-up signal, thereby being able to correctly receive the wake-up signal.

The embodiment of the present disclosure provides a method for receiving information, which is executed by a user equipment. The method can be executed independently or in combination with any other embodiment of the embodiment of the present disclosure. The method includes:
receiving configuration information from a network device, the configuration information being used to indicate resource information corresponding to a monitoring occasion of a wake-up signal, and determining resource information corresponding to the monitoring occasion based on the configuration information; and
receiving the wake-up signal sent by the network device based on the resource information corresponding to the monitoring occasion;
wherein the monitoring occasion is periodic, and the resource information includes one or more of time domain resource information, frequency domain resource information, and code domain resource information; and
the time domain resource information includes time domain cycle information, and the time domain cycle information includes a time domain cycle size and a cycle start position offset.

In one embodiment, a user equipment receives configuration information from a network device, the configuration information is used to indicate resource information corresponding to a monitoring occasion of a wake-up signal, and determines the resource information corresponding to the monitoring occasion based on the configuration information. The user equipment receives the wake-up signal sent by the network device based on the resource information corresponding to the monitoring occasion. The monitoring occasion is periodic, that is, the user equipment periodically receives the wake-up signal sent by the network device. The resource information includes one or more of time domain resource information, frequency domain resource information, and code domain resource information. The time domain resource information includes time domain period information, and the time domain period information includes the time domain period size and the period start position offset.

In the above implementation, the user equipment is in the RRC idle state or the RRC connected state.

In the above implementation, the user equipment determines the resource information corresponding to the monitoring occasion of the wake-up signal, so that the user equipment can obtain the time domain, frequency domain, and code domain resource information for receiving the wake-up signal, thereby being able to correctly receive the wake-up signal.

The embodiment of the present disclosure provides a method for receiving information, which is executed by a user equipment. The method can be executed independently or in combination with any other embodiment of the embodiment of the present disclosure. The method includes:
determining resource information corresponding to the monitoring occasion based on the communication protocol, where the resource information includes one or more of time domain resource information, frequency domain resource information, and code domain resource information; and
based on the resource information corresponding to the monitoring occasion, receiving the wake-up signal sent by the network device;
wherein, the monitoring occasion is periodic; and
the time domain resource information includes time domain cycle information, and the time domain cycle information includes a time domain cycle size and a cycle start position offset.

The user equipment determines the resource information corresponding to the monitoring occasion based on the communication protocol, and the resource information includes one or more of time domain resource information, frequency domain resource information and code domain resource information. The user equipment receives the wake-up signal sent by the network device based on the resource information corresponding to the monitoring occasion. The monitoring occasion is periodic, that is, the user equipment periodically receives the wake-up signal sent by the network device. The time domain resource information includes time domain cycle information, and the time domain cycle information includes the time domain cycle size and the cycle start position offset.

In the above implementation, the user equipment is in the RRC idle state or the RRC connected state.

In the above implementation, the user equipment determines the resource information corresponding to the monitoring occasion of the wake-up signal, so that the user equipment can obtain the time domain, frequency domain, and code domain resource information for receiving the wake-up signal, thereby being able to correctly receive the wake-up signal.

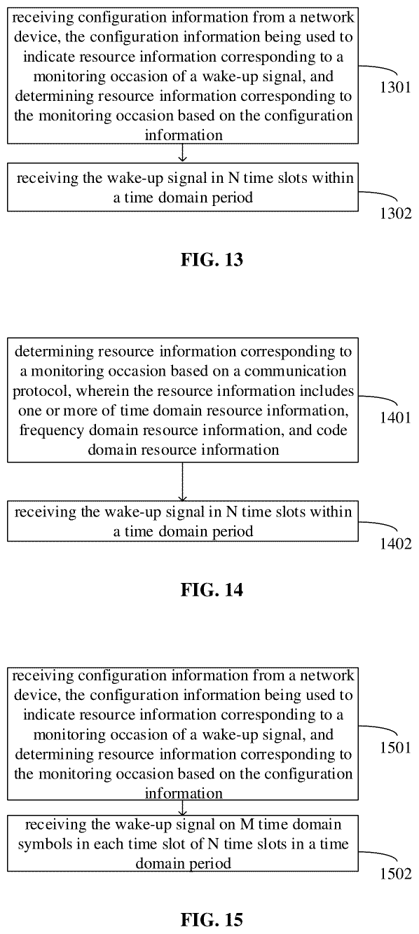

The embodiment of the present disclosure provides a method for receiving information, which is executed by a user equipment. The method can be executed independently or in combination with any other embodiment of the embodiment of the present disclosure. FIG. 13 is a flowchart of a method for receiving information according to an exemplary embodiment. As shown in FIG. 13, the method includes:
Step 1301, receiving configuration information from a network device, the configuration information being used to indicate resource information corresponding to a monitoring occasion of a wake-up signal, and determining resource information corresponding to the monitoring occasion based on the configuration information; and
Step 1302, receiving the wake-up signal in N time slots within a time domain period, where N is a positive integer greater than 1;
wherein the monitoring occasion is periodic, and the resource information includes one or more of time domain resource information, frequency domain resource information and code domain resource information.

In one embodiment, a user equipment receives configuration information from a network device, the configuration information is used to indicate resource information corresponding to a monitoring occasion of a wake-up signal, and determines the resource information corresponding to the monitoring occasion based on the configuration information, the resource information including one or more of time domain resource information, frequency domain resource information, and code domain resource information. The user equipment receives the wake-up signal sent by the network device based on the resource information corresponding to the monitoring occasion. The monitoring occasion is periodic. That is, within a time domain cycle, the user equipment receives the wake-up signal on N time slots of the time domain cycle. For example, the user equipment receives the wake-up signal on the first 4 time slots of a time domain cycle.

In one embodiment, a user equipment receives configuration information from a network device, the configuration information is used to indicate resource information corresponding to a monitoring occasion of a wake-up signal, and determines the resource information corresponding to the monitoring occasion based on the configuration information, wherein the resource information includes one or more of time domain resource information, frequency domain resource information, and code domain resource information. The user equipment receives a wake-up signal sent by the network device based on the resource information corresponding to the monitoring occasion. The monitoring occasion is periodic. That is, within a time domain period, the user equipment receives N sequences of wake-up signals in N time slots of the time domain period, respectively. In the embodiment, the wake-up signal is carried in sequences, and the N sequences are different. In this way, the user equipment can determine in which time slot each sequence is received by receiving the sequence of the wake-up signal.

In one embodiment, the value of N is configured by the network device. In one embodiment, the value of N is defined by the communication protocol.

In the above implementation, the user equipment is in the RRC idle state or the RRC connected state.

In the above implementation, the user equipment determines the resource information corresponding to the monitoring occasion of the wake-up signal, so that the user equipment can obtain the time domain, frequency domain, and code domain resource information for receiving the wake-up signal, thereby being able to correctly receive the wake-up signal.

The embodiment of the present disclosure provides a method for receiving information, which is executed by a user equipment. The method can be executed independently or in combination with any other embodiment of the embodiment of the present disclosure. FIG. 14 is a flowchart of a method for receiving information according to an exemplary embodiment. As shown in FIG. 14, the method includes:
Step 1401, determining resource information corresponding to a monitoring occasion based on a communication protocol, wherein the resource information includes one or more of time domain resource information, frequency domain resource information, and code domain resource information; and
Step 1402, receiving the wake-up signal in N time slots within a time domain period, where N is a positive integer greater than 1;
wherein the monitoring occasion is periodic.

The user equipment determines the resource information corresponding to the monitoring occasion based on the communication protocol, and the resource information includes one or more of time domain resource information, frequency domain resource information and code domain resource information. The user equipment receives the wake-up signal sent by the network device based on the resource information corresponding to the monitoring occasion. The monitoring occasion is periodic, that is, the user equipment periodically receives the wake-up signal sent by the network device. That is, within a time domain cycle, the user equipment receives the wake-up signal in N time slots of the time domain cycle. For example, the user equipment receives the wake-up signal in the first 4 time slots of a time domain cycle.

The user equipment determines the resource information corresponding to the monitoring occasion based on the communication protocol, and the resource information includes one or more of time domain resource information, frequency domain resource information and code domain resource information. The user equipment receives the wake-up signal sent by the network device based on the resource information corresponding to the monitoring occasion. That is, within a time domain period, the user equipment receives the wake-up signal in the N time slots of the time domain period. That is, within a time domain period, the user equipment receives N sequences of wake-up signals in the N time slots of the time domain period respectively. In the embodiment, the wake-up signal is carried in sequences, and the N sequences are different. In this way, the user equipment can determine in which time slot each sequence is received by receiving the sequence of the wake-up signal.

In one embodiment, the value of N is configured by the network device. In one embodiment, the value of N is defined by the communication protocol.

In the above implementation, the user equipment is in the RRC idle state or the RRC connected state.

In the above implementation, the user equipment determines the resource information corresponding to the monitoring occasion of the wake-up signal, so that the user equipment can obtain the time domain, frequency domain, and code domain resource information for receiving the wake-up signal, thereby being able to correctly receive the wake-up signal.

The embodiment of the present disclosure provides a method for receiving information, which is executed by a user equipment. The method can be executed independently or in combination with any other embodiment of the embodiment of the present disclosure. FIG. 15 is a flowchart of a method for receiving information according to an exemplary embodiment. As shown in FIG. 15, the method includes:
Step 1501, receiving configuration information from a network device, the configuration information being used to indicate resource information corresponding to a monitoring occasion of a wake-up signal, and determining resource information corresponding to the monitoring occasion based on the configuration information; and
Step 1502, receiving the wake-up signal on M time domain symbols in each time slot of N time slots in a time domain period, where N and M are both positive integers greater than 1;
wherein the monitoring occasion is periodic, and the resource information includes one or more of time domain resource information, frequency domain resource information and code domain resource information.

In one embodiment, a user equipment receives configuration information from a network device, the configuration information is used to indicate resource information corresponding to a monitoring occasion of a wake-up signal, and determines the resource information corresponding to the monitoring occasion based on the configuration information, the resource information including one or more of time domain resource information, frequency domain resource information, and code domain resource information. The user equipment receives the wake-up signal sent by the network device based on the resource information corresponding to the monitoring occasion. The monitoring occasion is periodic. That is, within a time domain cycle, the user equipment receives the wake-up signal on M time domain symbols in each of the N time slots of the time domain cycle. For example, the user equipment receives the wake-up signal on the first 4 time slots of a time domain cycle, and when receiving the wake-up signal on the first 4 time slots, the wake-up signal is received on the first 3 time domain symbols in each of the 4 time slots.

In one embodiment, a user equipment receives configuration information from a network device, the configuration information is used to indicate resource information corresponding to a monitoring occasion of a wake-up signal, and determines the resource information corresponding to the monitoring occasion based on the configuration information, the resource information including one or more of time domain resource information, frequency domain resource information, and code domain resource information. The user equipment receives the wake-up signal sent by the network device based on the resource information corresponding to the monitoring occasion. The monitoring occasion is periodic. That is, within a time domain period, the user equipment receives the wake-up signal on M time domain symbols in each of the N time slots of the time domain period, and receives M sequences of the wake-up signal on the M time domain symbols respectively. In the embodiment, the wake-up signal is carried in sequences, and the M sequences are different. In this way, the user equipment can determine on which time domain symbol each sequence is received by receiving the sequence of the wake-up signal.

In one embodiment, the values of N and M are configured by the network device. In one embodiment, the values of N and M are defined by the communication protocol.

In the above implementation, the user equipment is in the RRC idle state or the RRC connected state.

In the above implementation, the user equipment determines the resource information corresponding to the monitoring occasion of the wake-up signal, so that the user equipment can obtain the time domain, frequency domain, and code domain resource information for receiving the wake-up signal, thereby being able to correctly receive the wake-up signal.

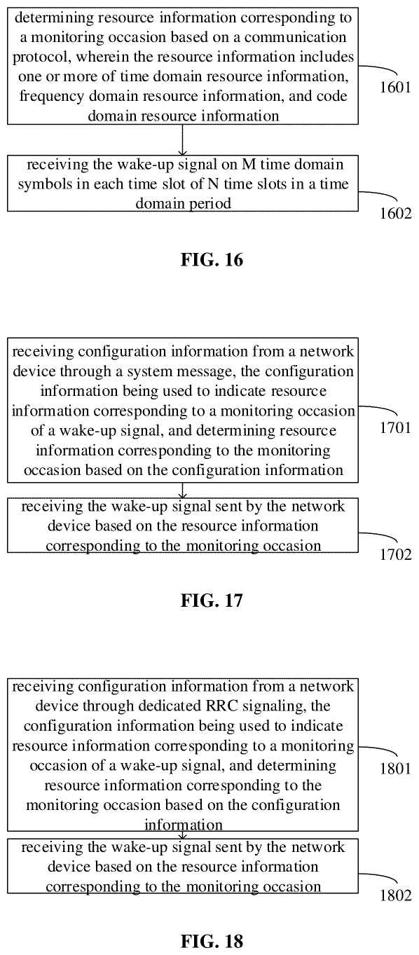

The embodiment of the present disclosure provides a method for receiving information, which is executed by a user equipment. The method can be executed independently or in combination with any other embodiment of the embodiment of the present disclosure. FIG. 16 is a flowchart of a method for receiving information according to an exemplary embodiment. As shown in FIG. 16, the method includes:
Step 1601, determining resource information corresponding to a monitoring occasion based on a communication protocol, wherein the resource information includes one or more of time domain resource information, frequency domain resource information, and code domain resource information; and
Step 1602, receiving the wake-up signal on M time domain symbols in each time slot of N time slots in a time domain period, where N and M are both positive integers greater than 1;
wherein the monitoring occasion is periodic.

The user equipment determines the resource information corresponding to the monitoring occasion based on the communication protocol, and the resource information includes one or more of time domain resource information, frequency domain resource information and code domain resource information. The user equipment receives the wake-up signal sent by the network device based on the resource information corresponding to the monitoring occasion. The monitoring occasion is periodic, that is, the user equipment periodically receives the wake-up signal sent by the network device. That is, within a time domain cycle, the user equipment receives the wake-up signal on M time domain symbols in each of the N time slots of the time domain cycle. For example, the user equipment receives the wake-up signal on the first 4 time slots of a time domain cycle, and when receiving the wake-up signal on the first 4 time slots, the wake-up signal is received on the first 3 time domain symbols in each of the 4 time slots.

The user equipment determines the resource information corresponding to the monitoring occasion based on the communication protocol, and the resource information includes one or more of time domain resource information, frequency domain resource information and code domain resource information. The user equipment receives the wake-up signal sent by the network device based on the resource information corresponding to the monitoring occasion. The monitoring occasion is periodic, that is, the user equipment periodically receives the wake-up signal sent by the network device. That is, within a time domain period, the user equipment receives the wake-up signal on the N time slots of the time domain period. That is, within a time domain period, the user equipment receives the wake-up signal on the M time domain symbols in each of the N time slots of the time domain period, and receives M sequences of the wake-up signal on the M time domain symbols respectively. In the embodiment, the wake-up signal is carried in sequences, and the M sequences are different. In this way, the user equipment can determine on which time domain symbol each sequence is received by receiving the sequence of the wake-up signal.

In one embodiment, the values of N and M are configured by the network device. In one embodiment, the values of N and M are defined by the communication protocol.

In the above implementation, the user equipment is in the RRC idle state or the RRC connected state.

In the above implementation, the user equipment determines the resource information corresponding to the monitoring occasion of the wake-up signal, so that the user equipment can obtain the time domain, frequency domain, and code domain resource information for receiving the wake-up signal, thereby being able to correctly receive the wake-up signal.

The embodiment of the present disclosure provides a method for receiving information, which is executed by a user equipment. The method can be executed independently or in combination with any other embodiment of the embodiment of the present disclosure. FIG. 17 is a flowchart of an information transmission method according to an exemplary embodiment. As shown in FIG. 17, the method includes:
Step 1701, receiving configuration information from a network device through a system message, the configuration information being used to indicate resource information corresponding to a monitoring occasion of a wake-up signal, and determining resource information corresponding to the monitoring occasion based on the configuration information; and
Step 1702, receiving the wake-up signal sent by the network device based on the resource information corresponding to the monitoring occasion;
wherein, the monitoring occasion is periodic; the resource information includes one or more of time domain resource information, frequency domain resource information and code domain resource information; and the user equipment is in an RRC idle state.

In one embodiment, the user equipment receives configuration information from the network equipment through a system message, the configuration information is used to indicate resource information corresponding to the monitoring occasion of the wake-up signal, and determines the resource information corresponding to the monitoring occasion based on the configuration information, and the user equipment receives the wake-up signal sent by the network equipment based on the resource information corresponding to the monitoring occasion. The monitoring occasion is periodic, that is, the user equipment periodically receives the wake-up signal sent by the network equipment. The resource information includes one or more of time domain resource information, frequency domain resource information, and code domain resource information.

In the above implementation, the user equipment is in the RRC idle state.

In the above implementation, the user equipment determines the resource information corresponding to the monitoring occasion of the wake-up signal, so that the user equipment can obtain the time domain, frequency domain, and code domain resource information for receiving the wake-up signal, thereby being able to correctly receive the wake-up signal.

The embodiment of the present disclosure provides a method for receiving information, which is executed by a user equipment. The method can be executed independently or in combination with any other embodiment of the embodiment of the present disclosure. FIG. 18 is a flowchart of an information transmission method according to an exemplary embodiment. As shown in FIG. 18, the method includes:
Step 1801, receiving configuration information from a network device through dedicated RRC signaling, the configuration information being used to indicate resource information corresponding to a monitoring occasion of a wake-up signal, and determining resource information corresponding to the monitoring occasion based on the configuration information; and
Step 1802, receiving the wake-up signal sent by the network device based on the resource information corresponding to the monitoring occasion;
wherein, the monitoring occasion is periodic; the resource information includes one or more of time domain resource information, frequency domain resource information and code domain resource information; and the user equipment is in an RRC connected state.

In one embodiment, the user equipment receives configuration information from the network equipment through dedicated RRC signaling, the configuration information is used to indicate resource information corresponding to the monitoring occasion of the wake-up signal, and determines the resource information corresponding to the monitoring occasion based on the configuration information. The user equipment receives the wake-up signal sent by the network equipment based on the resource information corresponding to the monitoring occasion. The monitoring occasion is periodic, that is, the user equipment periodically receives the wake-up signal sent by the network equipment. The resource information includes one or more of time domain resource information, frequency domain resource information, and code domain resource information.

In the above implementation, the user equipment is in the RRC connected state.

In the above implementation, the user equipment determines the resource information corresponding to the monitoring occasion of the wake-up signal, so that the user equipment can obtain the time domain, frequency domain, and code domain resource information for receiving the wake-up signal, thereby being able to correctly receive the wake-up signal.

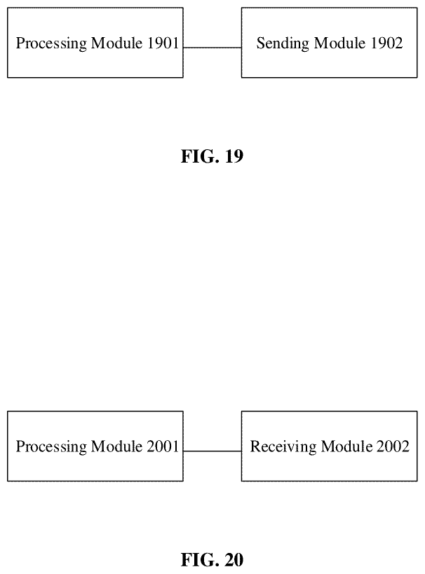

An embodiment of the present disclosure provides an information transmission apparatus, which is applied to a network device, as shown in FIG. 19, including:
a processing module 1901, configured to determine resource information corresponding to the sending occasion of the wake-up signal, where the resource information includes one or more of time domain resource information, frequency domain resource information, and code domain resource information; and
a sending module 1902, configured to send the wake-up signal to the user equipment based on the resource information corresponding to the sending occasion;
wherein the sending occasion is periodic.

An embodiment of the present disclosure provides an information receiving apparatus, which is applied to a user equipment, as shown in FIG. 20, including:
a processing module 2001, configured to determine resource information corresponding to the monitoring occasion of the wake-up signal, where the resource information includes one or more of time domain resource information, frequency domain resource information and code domain resource information; and
a receiving module 2002, configured to receive the wake-up signal sent by the network device based on the resource information corresponding to the monitoring occasion;
wherein the monitoring occasion is periodic.

An embodiment of the present disclosure provides a network device, including:
a processor; and
a memory for storing processor-executable instructions;
wherein the processor is configured to execute the executable instructions in the memory to implement the steps of the above-mentioned information transmission method.

An embodiment of the present disclosure provides a mobile terminal, including:
a processor; and
a memory for storing processor-executable instructions;
wherein the processor is configured to execute executable instructions in the memory to implement the steps of the above-mentioned information receiving method.

An embodiment of the present disclosure provides a non-temporary computer-readable storage medium on which executable instructions are stored. When the executable instructions are executed by a processor, the steps of the above-mentioned information transmission method or the above-mentioned information receiving method are implemented.

In view of this, the present disclosure provides an information transmission and reception method, apparatus, device and storage medium.

According to a first aspect of the embodiment of the present disclosure, there is provided an information transmission method, which is executed by a network device and includes:
determining resource information corresponding to a sending occasion of a wake-up signal, wherein the resource information includes one or more of time domain resource information, frequency domain resource information, and code domain resource information; and
sending the wake-up signal to a user equipment based on the resource information corresponding to the sending occasion,
wherein the sending occasion is periodic.

In one implementation, the determining the resource information corresponding to the sending occasion of the wake-up signal includes: determining, by the network device, configuration information, the configuration information being used to indicate the resource information corresponding to the sending occasion of the wake-up signal; and
the method further includes:
sending the configuration information to the user equipment.

In one implementation, determining the resource information corresponding to the sending occasion of the wake-up signal includes: determining the resource information corresponding to the sending occasion based on a communication protocol.

In one implementation, the frequency domain resource information includes frequency domain position information indicating that the frequency domain position for sending the wake-up signal is the same as the frequency domain position of the control resource set CORESET 0.

In one implementation, the frequency domain resource information includes frequency domain position information indicating that a center position of the frequency domain position for sending the wake-up signal is the same as a center position of the frequency domain position of CORESET 0.

In one implementation, the frequency domain resource information includes frequency domain position information indicating at least one of: a number of resource blocks occupied by the frequency domain position, and an index of a starting resource block in the resource blocks occupied by the frequency domain position.

In one implementation, the user equipment is in a radio resource control (RRC) idle state.

In one implementation, the frequency domain resource information includes frequency domain position information, and the frequency domain position information includes at least one of: a bandwidth part BWP where the wake-up signal is located, a number of resource blocks occupied by the frequency domain position, and an index of the starting resource block in the resource blocks occupied by the frequency domain position.

In one implementation, in response to the frequency domain resource information being determined based on a communication protocol, the frequency domain resource information includes frequency domain position information indicating that the frequency domain position of the wake-up signal is the same as a bandwidth position of an activated BWP of the user equipment.

In one implementation, in response to the frequency domain resource information being determined based on a communication protocol, the frequency domain resource information includes frequency domain location information indicating that the wake-up signal is on a default BWP, wherein the default BWP is specified by the communication protocol.

In one implementation, the user equipment is in a radio resource control (RRC) connected state.

In one implementation, the time domain resource information includes time domain cycle information, and the time domain cycle information includes a time domain cycle size and a cycle start position offset.

In one implementation, the time domain resource information includes time domain cycle information; and
the sending the wake-up signal to the user equipment based on the resource information corresponding to the sending occasion includes:
sending the wake-up signal in N time slots within a time domain cycle, wherein N is a positive integer greater than 1.

In one implementation, the sending the wake-up signal to the user equipment based on the resource information corresponding to the sending occasion further includes:
sending N sequences of the wake-up signal respectively on the N time slots;
wherein the wake-up signal is carried in sequences, and the N sequences are different.

In one implementation, the time domain resource information includes time domain cycle information; and
the sending the wake-up signal to the user equipment based on the resource information corresponding to the sending occasion includes:
sending the wake-up signal on M time domain symbols in each time slot of N time slots in a time domain period, wherein N and M are both positive integers greater than 1.

In one implementation, the sending the wake-up signal to the user equipment based on the resource information corresponding to the sending occasion further includes:
sending M sequences of the wake-up signal on the M time domain symbols respectively;
wherein the wake-up signal is carried in sequences, and the M sequences are different.

In one implementation, the user equipment is in an RRC idle state or an RRC connected state.

In one implementation, the sending the configuration information to the user equipment includes:
sending the configuration information to the user equipment through a system message; and
the user equipment is in an RRC idle state.

In one implementation, the sending the configuration information to the user equipment includes:
sending the configuration information to the user equipment through a dedicated RRC signaling; and
the user equipment is in an RRC connected state.

According to a second aspect of the embodiment of the present disclosure, there is provided an information receiving method, executed by a user equipment, including:
determining resource information corresponding to a monitoring occasion of a wake-up signal, wherein the resource information includes one or more of time domain resource information, frequency domain resource information, and code domain resource information; and
receiving the wake-up signal sent by a network device based on the resource information corresponding to the sending occasion,
wherein the monitoring occasion is periodic.

In one implementation, the determining resource information corresponding to the monitoring occasion of the wake-up signal includes:
receiving configuration information from the network device, the configuration information being used to indicate the resource information corresponding to the monitoring occasion of the wake-up signal; and
determining the resource information corresponding to the monitoring occasion based on the configuration information.

In one implementation, the determining resource information corresponding to the monitoring occasion of the wake-up signal includes:
determining the resource information corresponding to the monitoring occasion based on a communication protocol.

In one implementation, the determining resource information corresponding to the monitoring occasion of the wake-up signal includes:
in response to the frequency domain resource information not being determined based on configuration information received from the network device, determining that the frequency domain position of the wake-up signal is the same as a bandwidth position of an activated bandwidth part BWP of the user equipment; and
wherein the configuration information is used to indicate resource information corresponding to the monitoring occasion of the wake-up signal.

In one implementation, the determining resource information corresponding to the monitoring occasion of the wake-up signal includes:
in response to the frequency domain resource information not being determined based on configuration information received from the network device, determining that the wake-up signal is on a default BWP, wherein the default BWP is specified by a communication protocol; and
wherein the configuration information is used to indicate resource information corresponding to the monitoring occasion of the wake-up signal.

In one implementation, wherein the frequency domain resource information includes frequency domain position information indicating that the frequency domain position for receiving the wake-up signal is the same as the frequency domain position of the control resource set CORESET 0.

In one implementation, the frequency domain resource information includes frequency domain position information indicating that a center position of the frequency domain position for receiving the wake-up signal is the same as a center position of the frequency domain position of control resource set CORESET 0.

In one implementation, the frequency domain resource information includes frequency domain position information indicating at least one of: a number of resource blocks occupied by the frequency domain position, and an index of a starting resource block in the resource blocks occupied by the frequency domain position.

In one implementation, the user equipment is in a radio resource control (RRC) idle state.

In one implementation, the frequency domain resource information includes frequency domain position information, and the frequency domain position information includes at least one of: a BWP where the wake-up signal is located, a number of resource blocks occupied by the frequency domain position, and an index of the starting resource block in the resource blocks occupied by the frequency domain position.

In one implementation, in response to the frequency domain resource information being determined based on a communication protocol, the frequency domain resource information includes frequency domain position information indicating that the frequency domain position of the wake-up signal is the same as a bandwidth position of an activated BWP of the user equipment.

In one implementation, in response to the frequency domain resource information being determined based on a communication protocol, the frequency domain resource information includes frequency domain location information indicating that the wake-up signal is on a default BWP, wherein the default BWP is specified by the communication protocol.

In one implementation, the user equipment is in a radio resource control (RRC) connected state.

In one implementation, the time domain resource information includes time domain cycle information, and the time domain cycle information includes a time domain cycle size and a cycle start position offset.

In one implementation, the time domain resource information includes time domain cycle information; and
the receiving the wake-up signal sent by the network device based on the resource information corresponding to the monitoring occasion includes:
receiving the wake-up signal in N time slots within a time domain cycle, wherein N is a positive integer greater than 1.

In one implementation, the receiving the wake-up signal sent by the network device based on the resource information corresponding to the monitoring occasion further includes:
receiving N sequences of the wake-up signal respectively on the N time slots;
wherein the wake-up signal is carried in sequences, and the N sequences are different.

In one implementation, the time domain resource information includes time domain cycle information; and
the receiving the wake-up signal sent by the network device based on the resource information corresponding to the monitoring occasion includes:
receiving the wake-up signal on M time domain symbols in each time slot of N time slots in a time domain period, wherein N and M are both positive integers greater than 1.

In one implementation, the receiving the wake-up signal sent by the network device based on the resource information corresponding to the monitoring occasion further includes:
receiving M sequences of the wake-up signal on the M time domain symbols respectively;
wherein the wake-up signal is carried in sequences, and the M sequences are different.

In one implementation, the user equipment is in an RRC idle state or an RRC connected state.

In one implementation, the receiving the configuration information from the network device includes:
receiving the configuration information from the network device through a system message; and
the user equipment is in an RRC idle state.

In one implementation, the receiving the configuration information from the network device includes:
receiving the configuration information from the network device through a dedicated RRC signaling; and
the user equipment is in an RRC connected state.

According to a third aspect of the embodiment of the present disclosure, there is provided an information transmission apparatus, applied to a network device, including:
a processing module, configured to determine resource information corresponding to a sending occasion of a wake-up signal, wherein the resource information includes one or more of time domain resource information, frequency domain resource information, and code domain resource information; and
a sending module, configured to send the wake-up signal to a user equipment based on the resource information corresponding to the sending occasion;
wherein the sending occasion is periodic.

According to a fourth aspect of the embodiment of the present disclosure, there is provided an information receiving apparatus, applied to a user equipment, including:
a processing module, configured to determine resource information corresponding to a monitoring occasion of a wake-up signal, wherein the resource information includes one or more of time domain resource information, frequency domain resource information, and code domain resource information; and
a receiving module, configured to receive the wake-up signal sent by a network device based on the resource information corresponding to the sending occasion,
wherein the monitoring occasion is periodic.

According to a fifth aspect of the embodiment of the present disclosure, there is provided a network device, including:
a processor; and
a memory for storing processor-executable instructions;
wherein the processor is configured to execute executable instructions in the memory to implement steps of the above information transmission method.

According to a sixth aspect of the embodiment of the present disclosure, there is provided a mobile terminal, including:
a processor; and
a memory for storing processor-executable instructions;
wherein the processor is configured to execute executable instructions in the memory to implement steps of the above information receiving method.

According to a seventh aspect of the embodiment of the present disclosure, there is provided a non-transitory computer-readable storage medium having executable instructions stored thereon, which, when executed by a processor, implement steps of the above information transmission method or the above information receiving method.

The technical solution provided by the embodiments of the present disclosure may have the following beneficial effects:
In the above implementation, the network device determines the resource information corresponding to a sending occasion of a wake-up signal, so that the user equipment can obtain the time domain, frequency domain, and code domain resource information of the wake-up signal transmission, thereby being able to correctly receive the wake-up signal.

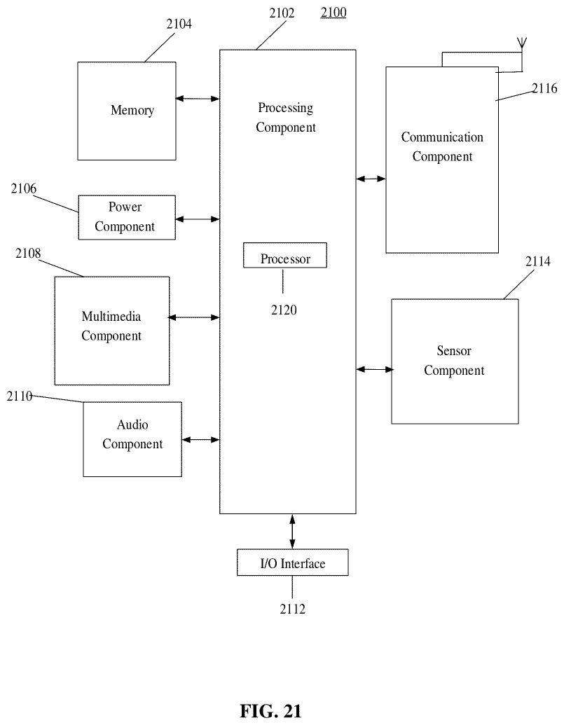

FIG. 21 is a block diagram of an information receiving device 2100 according to an exemplary embodiment. For example, the device 2100 may be a mobile phone, a computer, a digital broadcast terminal, a messaging device, a game console, a tablet device, a medical device, a fitness device, a personal digital assistant, etc.

Referring to FIG. 21, the device 2100 may include one or more of the following components: a processing component 2102, a memory 2104, a power supply component 2106, a multimedia component 2108, an audio component 2110, an input/output (I/O) interface 2112, a sensor component 2114, and a communication component 2116.

The processing component 2102 generally controls the overall operations of the device 2100, such as operations associated with display, telephone calls, data communications, camera operations, and recording operations. The processing component 2102 may include one or more processors 2120 to execute instructions to complete all or part of the steps of the above method. Additionally, processing component 2102 may include one or more modules that facilitate interaction between processing component 2102 and other components. For example, processing component 2102 may include a multimedia module to facilitate interaction between multimedia component 2108 and processing component 2102.

The memory 2104 is configured to store various types of data to support operations at the device 2100. Examples of such data include instructions for any application or method operating on the device 2100, contact data, phonebook data, messages, pictures, videos, etc. The memory 2104 can be realized by any type of volatile or non-volatile storage device or their combination, such as static random access memory (SRAM), electrically erasable programmable read only memory (EEPROM), erasable programmable read only memory (EPROM), programmable read only memory (PROM), read only memory (ROM), magnetic memory, flash memory, magnetic disk or optical disk.

The power supply component 2106 provides power to various components of the device 2100. The power component 2106 may include a power management system, one or more power supplies, and other components associated with generating, managing, and distributing power for device 2100.

The multimedia component 2108 includes a screen providing an output interface between the device 2100 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touches, swipes, and gestures on the touch panel. The touch sensor may not only sense a boundary of a touch or a swipe action, but also detect duration and pressure associated with the touch or swipe operation. In some embodiments, the multimedia component 2108 includes a front camera and/or a rear camera. When the device 2100 is in an operation mode, such as a photographing mode or a video mode, the front camera and/or the rear camera can receive external multimedia data. Each front camera and rear camera can be a fixed optical lens system or have focal length and optical zoom capability.

The audio component 2110 is configured to output and/or input audio signals. For example, the audio component 2110 includes a microphone (MIC), which is configured to receive an external audio signal when the device 2100 is in an operation mode, such as a call mode, a recording mode and a voice recognition mode. Received audio signals may be further stored in memory 2104 or sent via communication component 2116. In some embodiments, the audio component 2110 also includes a speaker for outputting audio signals.

The I/O interface 2112 provides an interface between the processing component 2102 and a peripheral interface module, which may be a keyboard, a click wheel, a button, and the like. These buttons may include, but are not limited to: a home button, volume buttons, start button, and lock button.

The sensor component 2114 includes one or more sensors for providing device 2100 with various aspects of status assessment. For example, the sensor component 2114 can detect the open/closed state of the device 2100, the relative positioning of components, such as the display and the keypad of the device 2100, the sensor component 2114 can also detect the device 2100 or a change in the position of a component of the device 2100, the presence or absence of user's contact with the device 2100, the change of orientation or acceleration/deceleration of the device 2100 and the temperature change of the device 2100. The sensor component 2114 may include a proximity sensor configured to detect the presence of nearby objects in the absence of any physical contact. The sensor component 2114 may also include an optical sensor, such as a CMOS or CCD image sensor, for use in imaging applications. In some embodiments, the sensor component 2114 may also include an acceleration sensor, a gyroscope sensor, a magnetic sensor, a pressure sensor or a temperature sensor.

The communication component 2116 is configured to facilitate wired or wireless communication between the device 2100 and other devices. The device 2100 can access a wireless network based on communication standards, such as Wi-Fi, 2G or 3G, or a combination thereof. In an exemplary embodiment, the communication component 2116 receives broadcast signals or broadcast related information from an external broadcast management system via a broadcast channel. In an exemplary embodiment, the communication component 2116 also includes a near field communication (NFC) module to facilitate short-range communication. For example, the NFC module can be implemented based on radio frequency identification (RFID) technology, infrared data association (IrDA) technology, ultra wideband (UWB) technology, bluetooth (BT) technology and other technologies.

In an exemplary embodiment, device 2100 may be implemented by one or more application specific integrated circuits (ASIC), digital signal processors (DSP), digital signal processing devices (DSPD), programmable logic devices (PLD), field programmable gate array (FPGA), controllers, microcontrollers, microprocessors or other electronic components for performing the method described above.

In an exemplary embodiment, there is also provided a non-transitory computer-readable storage medium including instructions, such as the memory 2104 including instructions, which can be executed by the processor 2120 of the device 2100 to implement the above method. For example, the non-transitory computer readable storage medium may be ROM, random access memory (RAM), CD-ROM, magnetic tape, floppy disk, and optical data storage device, and the like.

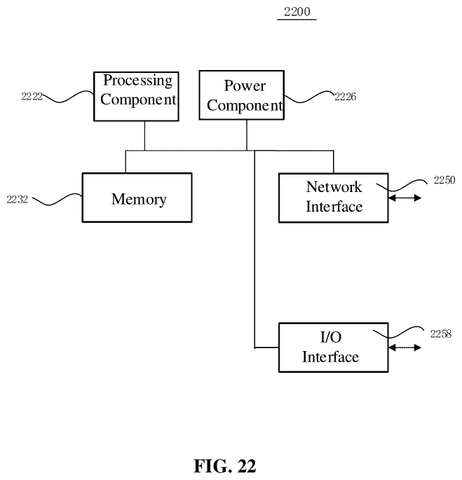

FIG. 22 is a block diagram of an information transmission device 2200 according to an exemplary embodiment. For example, the device 2200 may be provided as a base station. Referring to FIG. 22, the device 2200 includes a processing component 2222, which further includes one or more processors, and a memory resource represented by a memory 2232 for storing instructions executable by the processing component 2222, such as application programs. The application program stored in memory 2232 may include one or more modules each corresponding to a set of instructions. In addition, the processing component 2222 is configured to execute instructions, so as to perform the above information transmission method.

The device 2200 may also include a power component 2226 configured to perform power management of device 2200, a wired or wireless network interface 2250 configured to connect device 2200 to a network, and an input-output (I/O) interface 2258. The device 2200 can operate based on an operating system stored in the memory 2232, such as Windows Server™, Mac OS X™, Unix™, Linux™, FreeBSD™ or the like.

Other embodiments of the invention will be readily apparent to those skilled in the art from consideration of the specification and practice of the invention disclosed herein. This application is intended to cover any modification, use or adaptation of the present embodiments, these modifications, uses or adaptations follow the general principles of the embodiments of the present disclosure and include common knowledge or conventional technical means in the technical field not disclosed in this disclosure. The specification and examples are to be considered exemplary only, with a true scope and spirit of the embodiments of the present disclosure being indicated by the following claims.

It should be understood that the embodiments of the present disclosure is not limited to the precise constructions which have been described above and shown in the accompanying drawings, and various modifications and changes may be made without departing from the scope thereof. The scope of the embodiments of the present disclosure is limited only by the appended claims.

### INDUSTRIAL APPLICABILITY

In the above implementation, the network device determines the resource information corresponding to the sending occasion of the wake-up signal, so that the user equipment can obtain the time domain, frequency domain, and code domain resource information for sending the wake-up signal, thereby being able to correctly receive the wake-up signal.

1. An information transmission method, executed by a network device, comprising:
determining resource information corresponding to a sending occasion of a wake-up signal, wherein the resource information comprises one or more of time domain resource information, frequency domain resource information, and code domain resource information; and
sending the wake-up signal to a user equipment based on the resource information corresponding to the sending occasion,
wherein the sending occasion is periodic.

2. The method according to claim 1, wherein the determining the resource information corresponding to the sending occasion of the wake-up signal comprises: determining, by the network device, configuration information, the configuration information indicating the resource information corresponding to the sending occasion of the wake-up signal; and
the method further comprises:
sending the configuration information to the user equipment.

3. The method according to claim 1, wherein determining the resource information corresponding to the sending occasion of the wake-up signal comprises: determining the resource information corresponding to the sending occasion based on a communication protocol.

4. The method according to claim 2, wherein:
the frequency domain resource information comprises frequency domain position information indicating that a frequency domain position for sending the wake-up signal is the same as a frequency domain position of a control resource set CORESET 0;
the frequency domain resource information comprises frequency domain position information indicating that a center position of the frequency domain position for sending the wake-up signal is the same as a center position of the frequency domain position of CORESET 0; or
the frequency domain resource information comprises frequency domain position information indicating at least one of: a number of resource blocks occupied by the frequency domain position, and an index of a starting resource block in the resource blocks occupied by the frequency domain position.

5.-7. (canceled)

8. The method according to claim 2, wherein the frequency domain resource information comprises frequency domain position information, and the frequency domain position information comprises at least one of: a bandwidth part (BWP) where the wake-up signal is located, a number of resource blocks occupied by the frequency domain position, and an index of the starting resource block in the resource blocks occupied by the frequency domain position; or
wherein in response to the frequency domain resource information being determined based on a communication protocol, the frequency domain resource information comprises frequency domain position information indicating that the frequency domain position of the wake-up signal is the same as a bandwidth position of an activated BWP of the user equipment; or
in response to the frequency domain resource information being determined based on a communication protocol, the frequency domain resource information comprises frequency domain location information indicating that the wake-up signal is on a default BWP, wherein the default BWP is specified by the communication protocol.

9.-11. (canceled)

12. The method according to claim 2, wherein the time domain resource information comprises time domain cycle information, and the time domain cycle information comprises a time domain cycle size and a cycle start position offset.

13. The method according to claim 2, wherein the time domain resource information comprises time domain cycle information; and the sending the wake-up signal to the user equipment based on the resource information corresponding to the sending occasion comprises one of:
sending the wake-up signal in N time slots within a time domain cycle, wherein N is a positive integer greater than 1; or
sending the wake-up signal on M time domain symbols in each time slot of N time slots in a time domain period, wherein N and M are both positive integers greater than 1.

14. The method according to claim 13, wherein the sending the wake-up signal to the user equipment based on the resource information corresponding to the sending occasion further comprises one of:
sending N sequences of the wake-up signal respectively on the N time slots; wherein the wake-up signal is carried in sequences, and the N sequences are different; or
sending M sequences of the wake-up signal on the M time domain symbols respectively; wherein the wake-up signal is carried in sequences, and the M sequences are different.

15.-17. (canceled)

18. The method according to claim 2, wherein the sending the configuration information to the user equipment comprises one of:
sending the configuration information to the user equipment through a system message; and the user equipment is in an RRC idle state; or
sending the configuration information to the user equipment through a dedicated RRC signaling; and the user equipment is in an RRC connected state.

19. (canceled)

20. An information receiving method, executed by a user equipment, comprising:
determining resource information corresponding to a monitoring occasion of a wake-up signal, wherein the resource information comprises one or more of time domain resource information, frequency domain resource information, and code domain resource information; and
receiving the wake-up signal sent by a network device based on the resource information corresponding to the sending occasion,
wherein the monitoring occasion is periodic.

21. The method according to claim 20, wherein the determining resource information corresponding to the monitoring occasion of the wake-up signal comprises:
receiving configuration information from the network device, the configuration information indicating the resource information corresponding to the monitoring occasion of the wake-up signal; and
determining the resource information corresponding to the monitoring occasion based on the configuration information.

22. The method according to claim 20, wherein the determining resource information corresponding to the monitoring occasion of the wake-up signal comprises:
determining the resource information corresponding to the monitoring occasion based on a communication protocol.

23. The method according to claim 20, wherein the determining resource information corresponding to the monitoring occasion of the wake-up signal comprises:
in response to the frequency domain resource information not being determined based on configuration information received from the network device, determining that a frequency domain position of the wake-up signal is the same as a bandwidth position of an activated bandwidth part (BWP) of the user equipment, wherein the configuration information indicates resource information corresponding to the monitoring occasion of the wake-up signal; or that the wake-up signal is on a default BWP, wherein the default BWP is specified by a communication protocol, and the configuration information indicates resource information corresponding to the monitoring occasion of the wake-up signal.

24. (canceled)

25. The method according to claim 21, wherein;
the frequency domain resource information comprises frequency domain position information indicating that a frequency domain position for receiving the wake-up signal is the same as a frequency domain position of a control resource set CORESET 0;
the frequency domain resource information comprises frequency domain position information indicating that a center position of the frequency domain position for receiving the wake-up signal is the same as a center position of the frequency domain position of control resource set CORESET 0; or
the frequency domain resource information comprises frequency domain position information indicating at least one of: a number of resource blocks occupied by the frequency domain position, and an index of a starting resource block in the resource blocks occupied by the frequency domain position.

26.-28. (canceled)

29. The method according to claim 21, wherein the frequency domain resource information comprises frequency domain position information, and the frequency domain position information comprises at least one of: a bandwidth part (BWP) where the wake-up signal is located, a number of resource blocks occupied by the frequency domain position, and an index of the starting resource block in the resource blocks occupied by the frequency domain position; or
wherein in response to the frequency domain resource information being determined based on a communication protocol, the frequency domain resource information comprises frequency domain position information indicating that a frequency domain position of the wake-up signal is the same as a bandwidth position of an activated BWP of the user equipment; or
in response to the frequency domain resource information being determined based on a communication protocol, the frequency domain resource information comprises frequency domain location information indicating that the wake-up signal is on a default BWP, wherein the default BWP is specified by the communication protocol.

30.-32. (canceled)

33. The method according to claim 21, wherein the time domain resource information comprises time domain cycle information, and the time domain cycle information comprises a time domain cycle size and a cycle start position offset.

34. The method according to claim 21, wherein the time domain resource information comprises time domain cycle information; and the receiving the wake-up signal sent by the network device based on the resource information corresponding to the monitoring occasion comprises one of:
receiving the wake-up signal in N time slots within a time domain cycle, wherein N is a positive integer greater than 1; or
receiving the wake-up signal on M time domain symbols in each time slot of N time slots in a time domain period, wherein N and M are both positive integers greater than 1.

35. The method according to claim 34, wherein the receiving the wake-up signal sent by the network device based on the resource information corresponding to the monitoring occasion further comprises one of:
receiving N sequences of the wake-up signal respectively on the N time slots; wherein the wake-up signal is carried in sequences, and the N sequences are different; or
receiving M sequences of the wake-up signal on the M time domain symbols respectively; wherein the wake-up signal is carried in sequences, and the M sequences are different.

36.-42. (canceled)

43. A network device, comprising:
a processor; and
a memory for storing processor-executable instructions;
wherein the processor is configured to:
determine resource information corresponding to a sending occasion of a wake-up signal, wherein the resource information comprises one or more of time domain resource information, frequency domain resource information, and code domain resource information; and
send the wake-up signal to a user equipment based on the resource information corresponding to the sending occasion,
wherein the sending occasion is periodic.

44. A user equipment, comprising:
a processor; and
a memory for storing processor-executable instructions;
wherein the processor is configured to perform the method according to claim 20.

45. (canceled)
